(19) United States
(12) Patent Application Publication
(10) Pub. No.: US 2012/0041890 A1
(43) Pub. Date: Feb. 16, 2012

(54) SYSTEMS AND METHODS FOR ENABLING CONTRIBUTORS TO CREATE AND SHARE FINANCIAL ANALYSIS

(76) Inventor: Chee We Ng, Shanghai (CN)

(21) Appl. No.: 12/853,541

(22) Filed: Aug. 10, 2010

(51) Int. Cl. G06Q 40/00

(52) U.S. Cl. 705/36 R

(57) ABSTRACT

A system for enabling contributors to create and share financial analysis, the system includes a server configured to receive financial analysis contributions from contributors, the financial analysis contributions from each contributor including at least a prediction of a future price for a security; the server including a database configured to store the financial analysis contributions from contributors; the server being configured to receive ratings of at least one of contributors and financial analysis contributions; and the server being configured to make security price predictions based on contributions from multiple contributors, after making adjustments taking ratings into account. Other systems, methods, and computer readable media are disclosed.

### TECHNICAL FIELD

The technical field comprises technical analysis of securities. The technical field also comprises social networking. The technical field also comprises graphical user interfaces.

### BACKGROUND

This invention relates to the creation and dissemination of analysis of financial markets and macro-economy. In particular, deciding which stock to purchase, when to purchase and when to sell require understanding across the company, industry and the overall economy. Analyses are written by professionals and amateurs on different topics cutting across these various aspects.

The problem with these analyses is there is too much out there which are not well-written, resulting in confusion, a user being unable to differentiate a good analysis from a poor one, and a lack of trust. Poor analyses are often qualitative, without a methodology or structure, not comprehensive or integrative and do not integrate different aspects of analysis to derive a certain point of view.

### SUMMARY

Some embodiments provide a system for enabling contributors to create and share financial analysis, the system comprising a server configured to receive financial analysis contributions from contributors, the financial analysis contributions from each contributor including at least a prediction of a future price for a security. In some embodiments, the server includes a database configured to store the financial analysis contributions from contributors. In some embodiments, the server is configured to receive ratings of at least one of contributors and financial analysis contributions. In some embodiments, the server is configured to make security price predictions based on contributions from multiple contributors, after making adjustments taking ratings into account. In some embodiments, the server being configured to calculate amounts to compensate respective contributors based, at least in part, on the ratings.

In some embodiments, the system is configured to input screening criteria and to output rankings of securities based on at least the screening criteria and security price predictions.

In some embodiments, financial analysis contributions from different contributors are aggregated. Some embodiments provide a method for enabling contributors to create and share financial analysis, the method comprising presenting financial statement numbers reported by a company; receiving financial analysis contributions from contributors, the financial analysis contributions from respective contributors including accounting adjustments representing suggested modifications to the accounting numbers, and the financial analysis contributions including commentary on the company by the contributors; storing accounting adjustments from respective contributors; and calculating, using a processor, financial data, using accounting adjustments from multiple of the contributors.

Some embodiments provide a method for enabling contributors to create and share financial analysis, the method comprising receiving financial analysis contributions from contributors; storing the financial analysis contributions from contributors; and receiving a definition of a custom fund from a contributor, the custom fund definition including specification of multiple companies and how much of each company to include. In some embodiments, performance of funds is tracked. In some embodiments, a graph of fund performance relative to time is generated. In some embodiments, revisions of definitions of funds are received. In some embodiments, the financial analysis contributions from contributors include commentary for a security.

Various combinations of these features are possible.

### BRIEF DESCRIPTION OF THE VIEWS OF THE DRAWINGS

FIG. 1 is a block diagram of a system in accordance with various embodiments.

FIG. 2 is a more detailed block diagram of the system of FIG. 1.

FIG. 3 is a stock and dividend graph, generated by the system of FIG. 1, showing share price and dividends versus time, in accordance with various embodiments.

FIG. 4 is an annualized return graph showing capital gains and dividends over various time periods, in accordance with various embodiments.

FIG. 5 is map showing how a screen shot will be divided up into FIGS. 5A-5D. When assembled as shown in FIG. 5, FIGS. 5A, 5B, 5C, and 5D provide a screen shot of a screen, generated by the system of FIG. 1, showing a financial statement as reported and a recast financial statement, in accordance with various embodiments.

FIG. 5A is a portion of a screen shot, in accordance with various embodiments.

FIG. 5B is a portion of a screen shot, in accordance with various embodiments.

FIG. 5C is a portion of a screen shot, in accordance with various embodiments.

FIG. 5D is a portion of a screen shot, in accordance with various embodiments.

FIG. 6 is a graph, generated by the system of FIG. 1, showing sales and profit versus time, in accordance with various embodiments.

FIG. 7 is a graph, generated by the system of FIG. 1, showing Return on Invested Capital versus time, in accordance with various embodiments.

FIG. 8 is a graph, generated by the system of FIG. 1, showing a breakdown of Net Operating Profit After Taxes Margin (NOPLAT/Sales) by EBITDA, Cost of Goods Sold (COGS), Sales, General and Administrative (SG&A) and Research and Development (R&D) versus time, in accordance with various embodiments.

FIG. 9 is a graph, generated by the system of FIG. 1, showing a breakdown of Invested Capital/Sales by Plant Property & Equipment (PP&E), Working Capital (WC), Other Operating Assets (Other Opr Asset), Adjustments (Adj) and Others versus time, in accordance with various embodiments.

FIG. 10 is a graph, generated by the system of FIG. 1, showing a breakdown of investor assets by components: Plant Property & Equipment (PP&E), Working Capital (WC), Other Operating Assets (Other Opr Asset), Adjustments (Adj), Cash and Marketable Securities (Cash/MktSec) and Others, in accordance with various embodiments.

FIG. 11 is a graph, generated by the system of FIG. 1, comparing two companies, funds, or entities for growth such as revenue growth and NOPAT growth, in accordance with various embodiments.

FIG. 12 is a graph, generated by the system of FIG. 1, comparing two companies, funds, or entities for Return on Invested Capital, in accordance with various embodiments. In the illustrated embodiment, NOPLAT/Sales (%) and Sales/Invested Capital are also compared.

FIG. 13 is a graph, generated by the system of FIG. 1, comparing two companies, funds, or entities for breakdown of Net Operating Profit After Taxes Margin (NOPLAT/Sales) by EBITDA, Cost of Goods Sold (COGS), Sales, General and Administrative (SG&A) and Research and Development (R&D) and other costs, in accordance with various embodiments.

FIG. 14 is a graph, generated by the system of FIG. 1, comparing two companies, funds, or entities for breakdown of Invested Capital/Sales by Plant Property & Equipment (PP&E), Working Capital (WC), Other Operating Assets (Other Opr Asset), and Adjustments (Adj), in accordance with various embodiments.

FIG. 15 is a graph, generated by the system of FIG. 1, comparing two companies, funds, or entities for breakdown of investor assets by Plant Property & Equipment (PP&E), Working Capital (WC), Other Operating Assets (Other Opr Asset), Adjustments (Adj), Cash and Marketable Securities (Cash/MktSec) and Others, in accordance with various embodiments.

FIG. 16 is a block diagram illustrating using adjusting accounting numbers from contributors to generate best adjusted accounting numbers, using the system of FIG. 1, in accordance with various embodiments.

FIG. 17 is a map showing how FIGS. 17A and 17B are to be assembled. When assembled in the manner shown in FIG. 17, FIGS. 17A and 17B define a screen shot illustrating a contributor's commentary being attached to the bottom of the graphs by the system of FIG. 1, in various embodiments.

FIG. 17A is a portion of a screen shot, in accordance with various embodiments.

FIG. 17B is a portion of a screen shot, in accordance with various embodiments.

FIG. 18 is a map showing how FIGS. 18A and 18B are to be assembled. When assembled in the manner shown in FIG. 18, FIGS. 18A and 18B define screen-shot of an example of a standardized model template provided by the system of FIG. 1, in various embodiments. Different templates have different inputs.

FIG. 18A is a portion of a screen shot, in accordance with various embodiments.

18B is a portion of a screen shot, in accordance with various embodiments.

FIG. 19 is a graph, generated by the system of FIG. 1, showing the value of a company with respect to its Invested Capital, in accordance with various embodiments.

FIG. 20 is a graph, generated by the system of FIG. 1, showing the breakdown of the Enterprise Value into multiple parts, in accordance with various embodiments.

FIG. 21 is a graph, generated by the system of FIG. 1, comparing the values of companies relative to invested capital, in accordance with various embodiments.

FIG. 22 is a graph, generated by the system of FIG. 1, showing the breakdown of the Enterprise Value into multiple parts, in accordance with various embodiments.

FIG. 23 is a screen shot of a screen, generated by the system of FIG. 1, illustrating revision history, since contributors may revise write-ups of others or their own write-ups, in accordance with various embodiments.

FIG. 24 is a map showing how FIGS. 24A and 24B are to be assembled. When assembled in the manner shown in FIG. 24, FIGS. 24A and 24B define a screen shot of a screen, generated by the system of FIG. 1, illustrating a section of a master write-up, where the commentary has been consolidated by section, in accordance with various embodiments.

FIG. 24A is a portion of a screen shot, in accordance with various embodiments.

FIG. 24B is a portion of a screen shot, in accordance with various embodiments.

FIG. 25 is a screen shot of an interface, generated by the system of FIG. 1, using which a contribution by a contributor can be rated.

FIG. 26 is a map showing how FIGS. 26A, 26B, and 26C are to be assembled. When assembled in the manner shown in FIG. 26, FIGS. 26A, 26B, and 26C define a screen shot of a screen, showing a ranking of companies generated by the system of FIG. 1, in accordance with various embodiments.

FIG. 26A is a portion of a screen shot, in accordance with various embodiments.

FIG. 26B is a portion of a screen shot, in accordance with various embodiments.

FIG. 26C is a portion of a screen shot, in accordance with various embodiments.

FIG. 27 is a map showing how FIGS. 27A, 27B, and 27C are to be assembled. When assembled in the manner shown in FIG. 27, FIGS. 27A, 27B, and 27C define a screen shot of an interface, generated by the system of FIG. 1, using which companies can be screened based on various criteria.

FIG. 27A is a portion of a screen shot, in accordance with various embodiments.

FIG. 27B is a portion of a screen shot, in accordance with various embodiments.

FIG. 27C is a portion of a screen shot, in accordance with various embodiments.

FIG. 28 is a screen shot of an interface, generated by the system of FIG. 1, using which a user can input a list of stocks in which to invest, and in what percentage, so as to define a custom fund, in accordance with various embodiments.

FIG. 29 is a graph, generated by the system of FIG. 1 in various embodiments, illustrating how a fund of FIG. 28 has grown in time in price and showing dividends.

FIG. 30 is a graph, generated by the system of FIG. 1 in various embodiments, illustrating how a fund of FIG. 28 has grown in time based on capital gains and dividends using a format different from the format of FIG. 29.

### DETAILED DESCRIPTION OF THE ILLUSTRATED EMBODIMENTS

Various embodiments provide rich commentary and interpretation to models and graphs for financial analysis.

Some embodiments provide a novel platform or system that fosters the creation of quality analysis, those that are quantitative, comprehensive and provide rich commentary and interpretation. The platform or system organizes individual write-ups in a way that let users read and compare different views easily. The platform or system also stores the data generated in each analysis in a standardized manner to enable rich data-mining.

In various embodiments, the following terms usually have the following meanings.

The term “Accounting adjustment” refers to a subjective amendment to publicly announced Accounting numbers to make them comparable to those of other companies and to be closer to economic truth.

“Accounting numbers” comprise metrics like revenue, net income, equity that pertains to a company and that are typically publicly disclosed.

The term “Adjusted financial metrics” refers to financial metrics computed based on Accounting numbers and Accounting adjustments, such as Net Operating Profit After Taxes and Invested Capital.

The term “Awards” refers to recognition given to Contributors and Write-ups for having met certain achievements, such as longest stretch of outperforming.

The term “Comment” refers to a text contributed by a user regarding an analysis.

The term “Commentary” refers to the text that interprets or explains the insight related to a Tool or graph.

The term “Contributor” refers to a person who creates a Write-up.

“Data” includes accounting numbers, accounting adjustments, adjusted financial metrics and other economic data.

“Data-mining” comprises processes performed on Data, including calculations of medians, average, weighted average, standard deviation, selected weighted average by rating and others to produce a better estimate of the economic truth.

The term “Discussion” refers to an exchange of points of views, typically in the form of text, by various users regarding a topic.

The term “Master write-up” refers to a consolidated view of all the Write-ups for a particular topic.

The term “Metric” refers to a calculated quantity that is a measure for a certain aspects, such as return on equity for a company, and gross domestic product for a country.

The term “Model” refers to something that computes a financial or economic quantity based on certain inputs. It can be in the form of a spreadsheet or a Tool, for example.

The term “Methodology” refers to a sequence of steps used to develop an Analysis. A good Methodology is based on sound academic theories about a topic.

A “Platform” comprises hardware employed in various embodiments.

The term “Recast financial statements” refers to financial statements that are re-organized during financial analysis so that Accounting adjustments can be added and Adjusted financial metrics can be calculated.

The term “Section” refers to a portion in the Structure of a Write-up.

The term “Structure” refers to division of a Write-up into distinct sections. Good structure is based on industry best practice and academic theories.

A “Tool” comprises graphs, Metrics, and Models on the platform which is used for a type of financial or economic analysis. A Tool may come with a Commentary that provides the interpretation of the output.

The term “Topic” refers to a company, an industry, a country or any other entity that a Write-up is about.

A “Write-up” comprises a detailed analysis about a topic, which often includes data, metrics, graphs, models and commentary. It can be in digital form or on paper.

While the above definitions are intended to aid the reader in understanding the Detailed Description, they are not intended to be limiting or rigid. Terms used in the Claims are to be given their ordinary meanings.

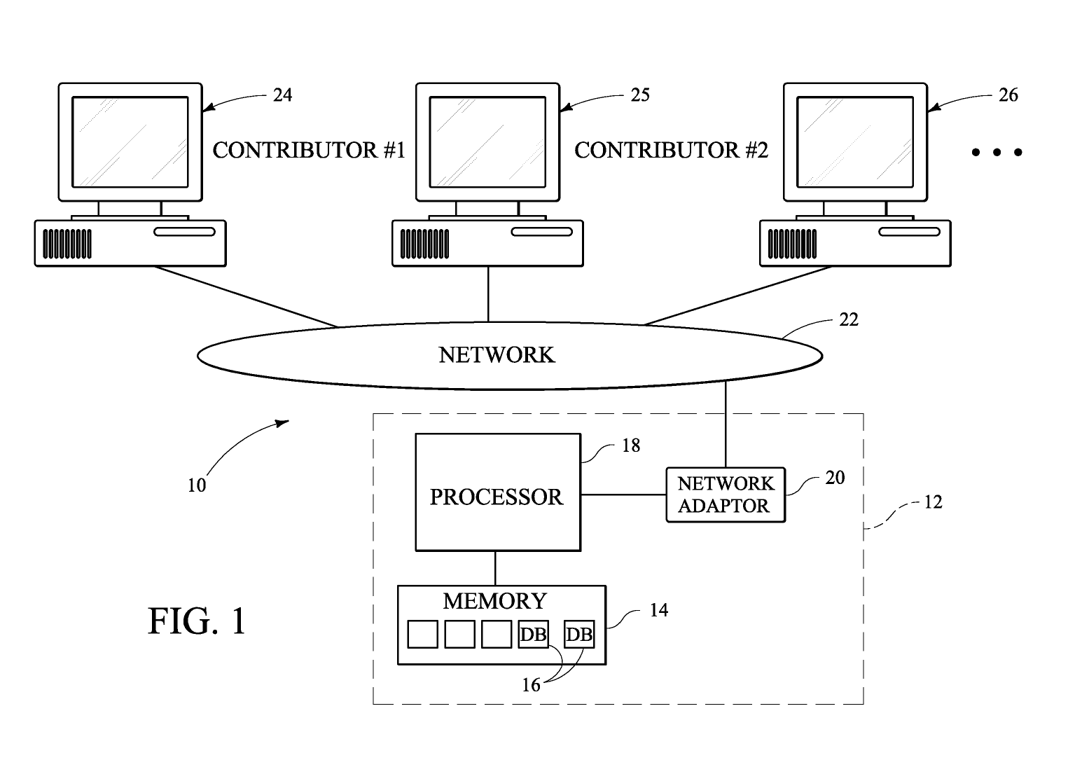

FIG. 1 shows a platform or system 10 in accordance with various embodiments. The system 10 includes a server 12 including memory 14 defining one or more databases 16. The database or databases 16 store data and write-ups. The server 12 also includes one or more processors 18 in communication with the memory 14. The server 12 also includes one or more network adapters 20 enabling communication with a network 22 such as the Internet. Contributors use terminals 24, 25, 26, etc. to communicate with the server 12.

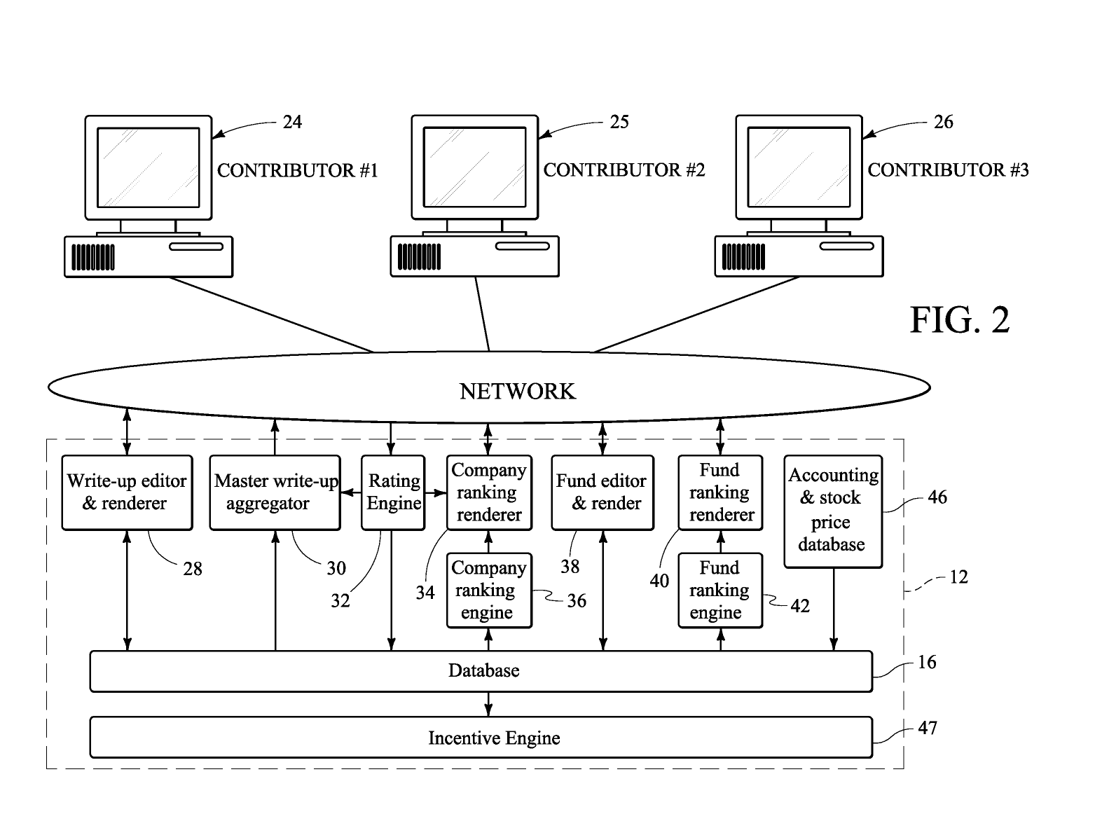

FIG. 2 illustrates that the system 10, in various embodiments comprises various modules. The modules can comprise, in various embodiments any desired combination of modules that: enable a contributor to create and share sophisticated analysis easily (see, e.g., write-up editor & renderer 28); organize write-ups of a single topic by different contributors into a master write-up (see, e.g., master write-up aggregator 30); develop ratings for contributors (see, e.g., rating engine 32); rank stocks to purchase by different criteria (see, e.g., company ranking renderer 34 and company ranking engine 36); allow a user to create and maintain a fund, and automatically keeps track of the performance of the fund 38 (see, e.g., fund editor & renderer 38); rank funds by difference criteria (see, e.g., fund ranking renderer 40 and fund ranking engine 42); store securities prices over time (see, e.g., accounting & stock price database 46); and calculate and provide incentives for contributors by calculating a dividend based on the quality and quantity of contributed write-ups (see, e.g., incentive engine 47).

Various embodiments provide a platform that automates financial analysis and embeds rich commentary to the analysis. Various features of the platform will now be described, some or all of which features are included in different embodiments.

In some embodiments, write-ups require a contributor to input his or her prediction of a future stock price. As will be explained later, this allows the platform to make a prediction a stock's price after adjusting for ratings.

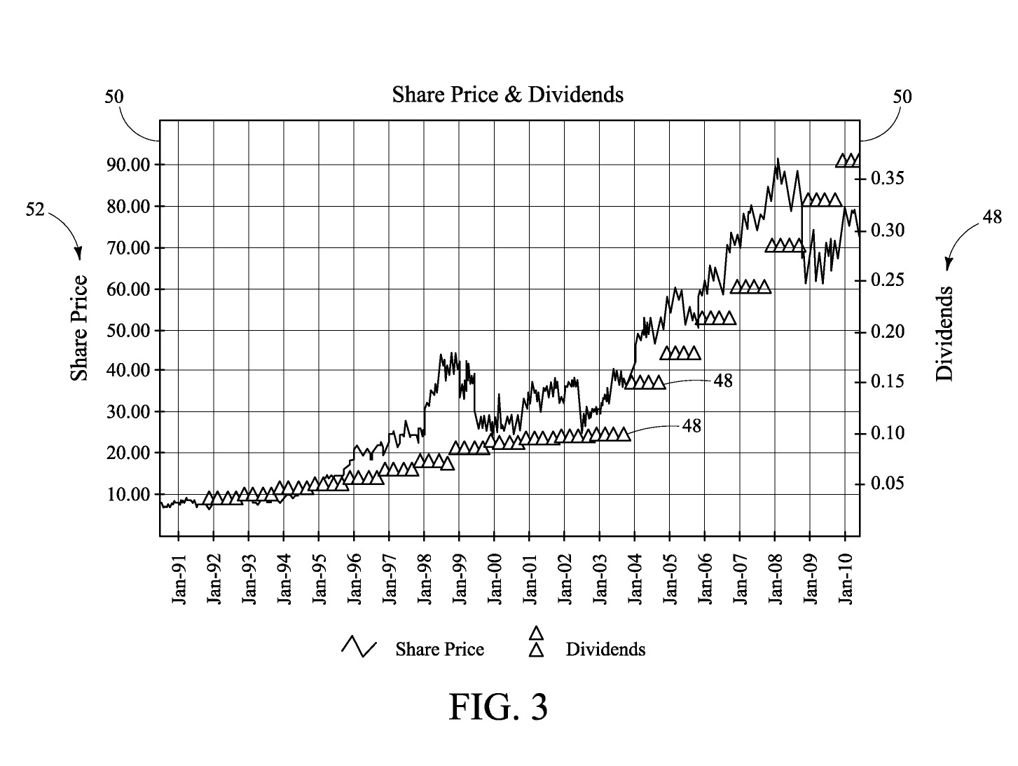

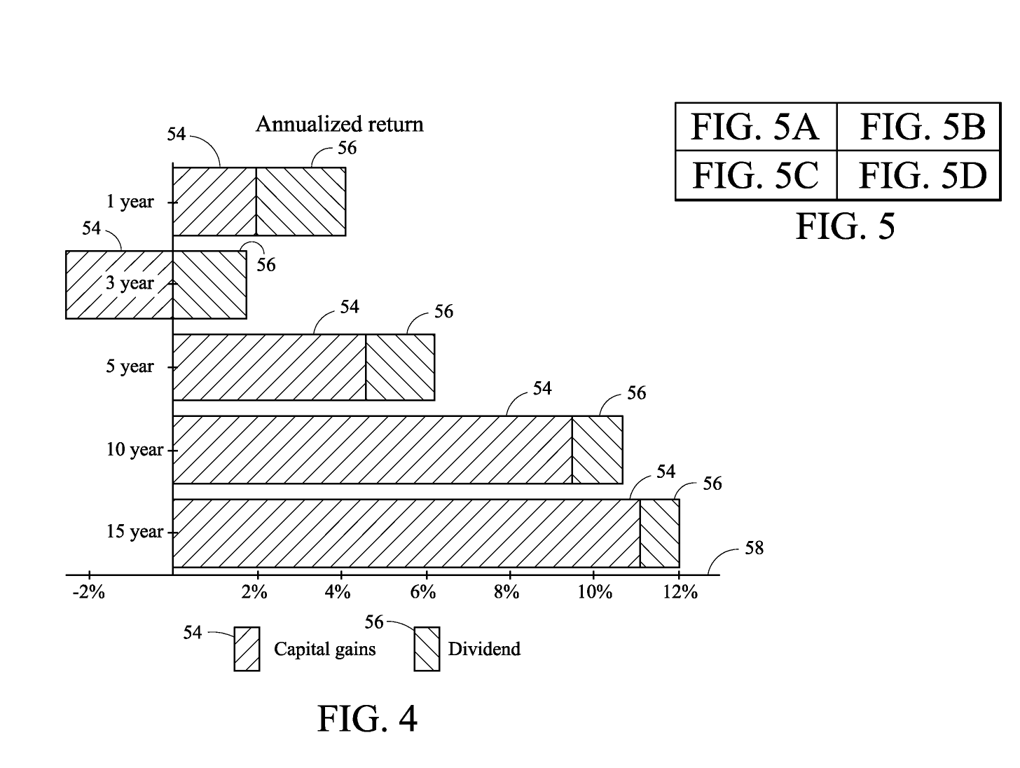

In various embodiments, the graphs in FIGS. 3 and 4 are generated by the system 10 in response to a write-up for a stock or security being created.

In some embodiments, dividends 48 are plotted on the same graph as stock or security price 52. This is useful because returns from investing in a stock come from both stock price increases as well as the dividend return. The graph like FIG. 3 shows in a very visual way if a company has been issuing dividends regularly and if those dividends have been increasing or decreasing over time.

In some embodiments, a graph such as the one shown in FIG. 4 is generated by the system 10 (e.g., in response to a write-up for a stock or security being generated). While cross hatches are used in the figure to distinguish capital gains 54 from dividends 56, in actual implementations, colors may be used to distinguish capital gains from dividends. In FIG. 4, dividends 56 are plotted on the same axis 58 as capital gains.

FIG. 4 is also a very visual way to view the annualized performance of a stock if an investor had invested in the stock, for example, one, three, five, ten or fifteen years ago from today. This is a way of summarizing the historical performance of a stock over this period. Normally, the calculations would have to be calculated via a model repeatedly. In various embodiments, the system 10 downloads data and computes and renders this graph (e.g., automatically).

In various embodiments, together, these two graphs visually show overall, if a stock price has been performing well over the historical period; and where the stock returns come from—capital gains or dividend gains or both. These graphs not only help a contributor perform an analysis, they are added to a write-up (e.g., automatically). This helps improve the quality of write-ups.

In some embodiments, these graphs are updated (e.g., automatically) by the platform using data from a stock and dividend database, without any user intervention. This updating can happen, for example, from time to time, periodically, or whenever such graphs are viewed by a viewer.

Analysis of accounting numbers can be a useful step in analysis of a company's performance. The system 10, in various embodiments, automates and makes the analysis process easier.

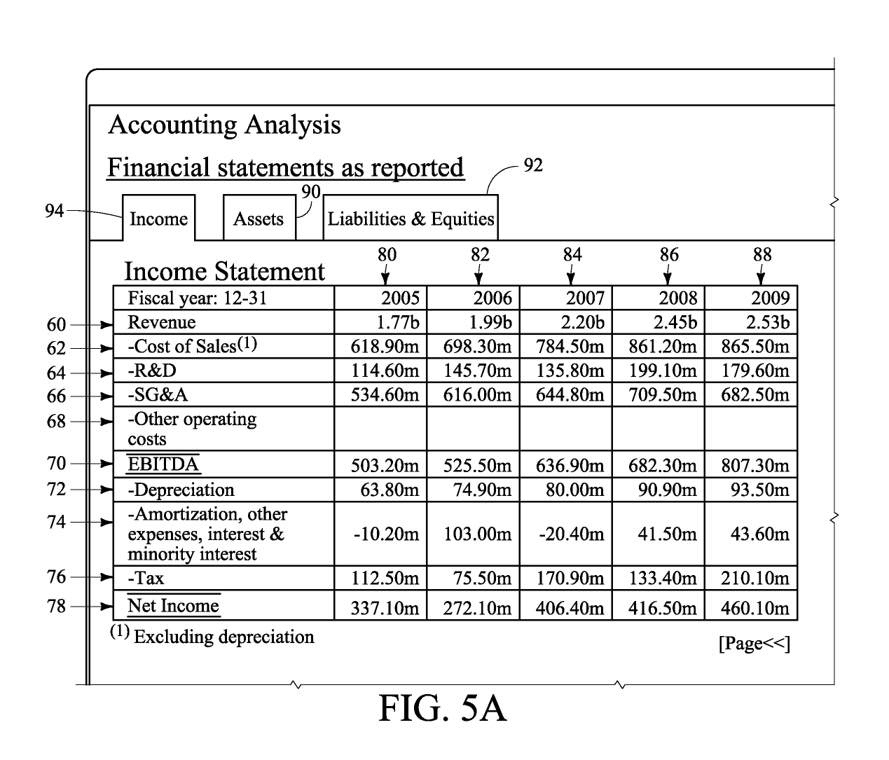

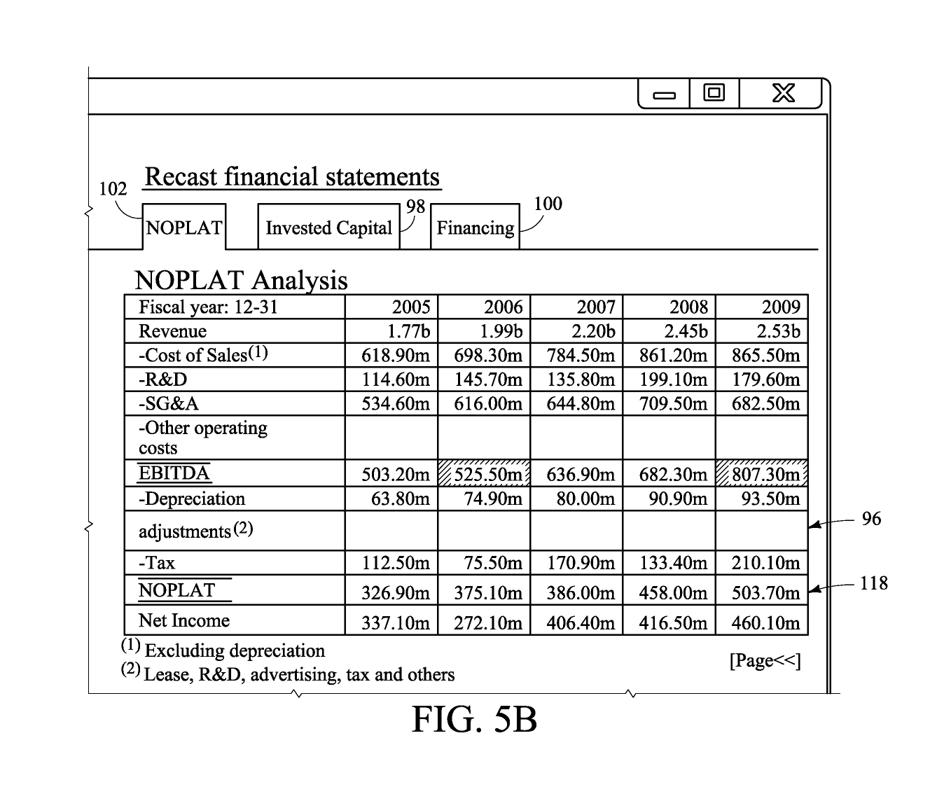

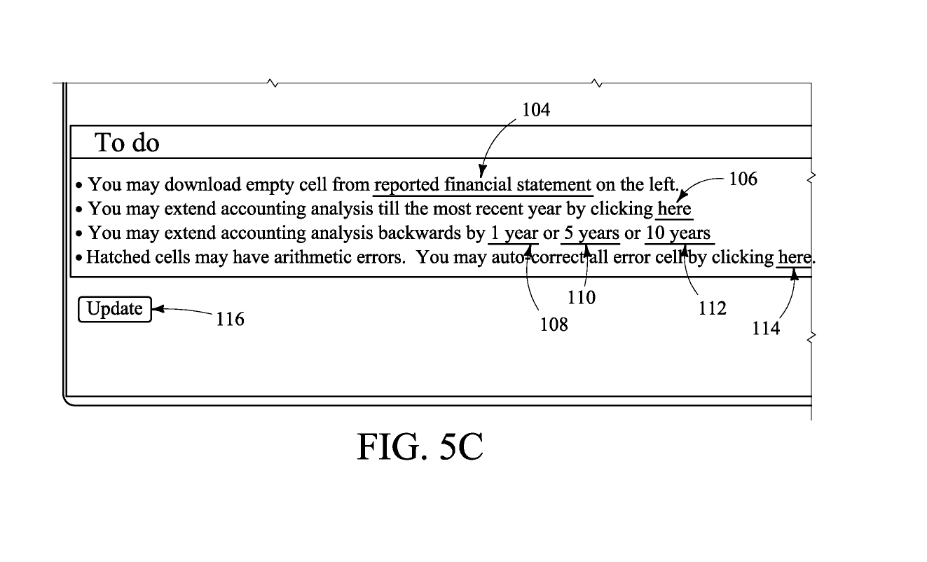

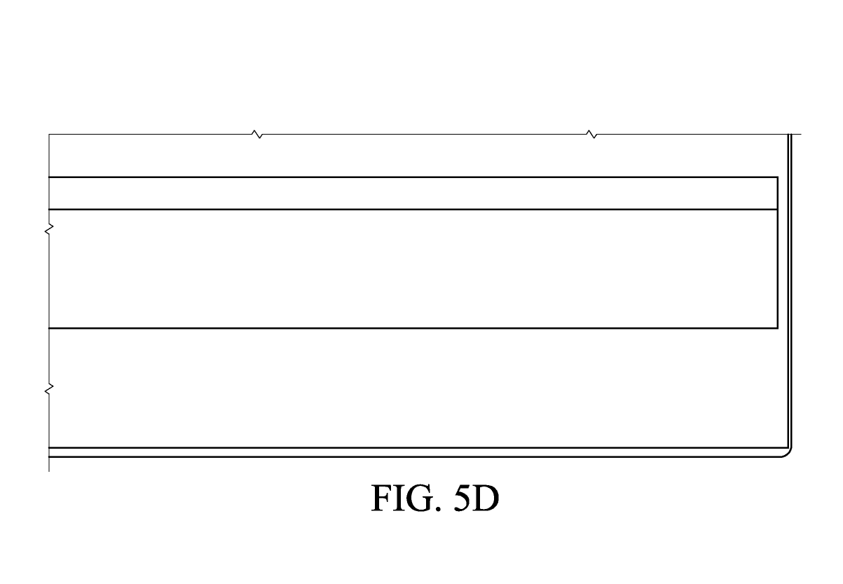

In various embodiments, the system 10 assists with accounting analysis by one or more of (1) recasting financial statements, (2) inputting adjustments to accounting numbers, and (3) calculating certain adjusted financial metrics used to perform analysis of a company. FIGS. 5A-5D, when assembled together in the manner shown in FIG. 5, show a screen shot of how accounting analysis has been automated in the current invention. In various embodiments, the system 10 has, in a database 46, publicly reported accounting numbers of a company. Alternatively, the system 10 may be configured to access accounting numbers from outside the system 10.

Publicly reported accounting numbers are shown in FIG. 5A. FIG. 5B, the right hand side of a screen, is a recast financial statement. These numbers can include, for example, one or more of: revenue 60; cost of sales 62; R&D 64; SG&A 66; other operating costs 68; EBITDA 70; depreciation 72; amortization, other expenses, interest & minority interest 74; tax 76; and net income 78. In the illustrated embodiment, such numbers are displayed simultaneously for multiple years 80, 82, 84, 86, 88. Some numbers, such as EBITDA and net income can be calculated based on other numbers, in some embodiments.

In the illustrated embodiment, a user can reveal other numbers by clicking on, actuating, or selecting buttons or tabs 90 for assets and 92 for liabilities and equities, for example, and can return to income using button or tab 94. Various embodiments allow the user to auto-fill in FIG. 5B the recast financial statement using data 60, 62, 64, 66, 68, 70, 74, 76, and 78 as reported in the financial statement shown in FIG. 5A, and then perform accounting adjustments to the accounting numbers. In some embodiments, adjustments are made in a row 96 titled ‘adjustments’. In other embodiments, numbers in FIG. 5B can be edited. Accounting adjustments are used to bridge the gap between accounting numbers and ‘economic truth.’ Corporate managers, for various reasons from time to time misstate accounting numbers and hence financial statements deviate from the ‘economic truth.’ Developing accounting adjustments is useful in financial analysis to reveal the ‘economic truth’, and good analysis depends on having good adjusted numbers. However, accounting adjustments, unlike accounting numbers, are a result of subjective judgment by the contributor. In the illustrated embodiment, a user can reveal other numbers by clicking on, actuating, or selecting buttons or tabs 98 for invested capital and 100 for financing, for example, and can return to a NOPLAT analysis tab or page using button or tab 102. The goal of the NOPLAT analysis tab 102 is to calculate the best economic estimate of Net Operating Profit After Tax (NOPLAT or NOPAT), while that of tab 98 is to calculate the best economic estimate of Invested Capital, and that of tab 100 is to calculate the capital structure of the company. Tab 98 allows for accounting adjustments for assets in a similar way for revenue and profit under tab 102, and calculates Invested Capital, which is a better estimate of useful economic assets than publicly disclosed Total Assets or Total Operating Assets. Tab 100 calculates the Total debt and Debt Equivalents and Total Equity and Equity equivalents, which are different from publicly disclosed Total Debt and Total Equity. As an example, long-term leases are both a form of asset and a form of debt economically, but neither are included under Total Assets or Total Debt in publicly announced numbers. Various options are available by clicking on or actuating links or buttons 104, 106, 108, 110, 112, and 114 in FIG. 5C. For example, in the illustrated embodiment, a user can auto-fill empty cells from a financial statement of FIG. 5A by clicking on or actuating link or button 104, can extend an accounting analysis until the most recent year by clicking on or actuating link or button 106, can extend the accounting analysis backwards for one, five or ten years by clicking on or actuating link or button 108, 110, or 112, respectively, or can auto-correct errors in cells by clicking on or actuating link or button 114. An update button or link 116 is also included, using which a user can store accounting adjustments. In some embodiments, prior to auto-correction of errors, suspected errors in numbers are indicated by using a different color than for numbers that are believed to be correct (e.g., EBITDA for 2009 is shaded for this reason).

In various embodiments, write-ups from different contributors each have their own set of accounting adjustments. Whereas an individual's set of accounting adjustments may have mistakes or biases, an average or median or weighted average of several sets of accounting adjustments will have fewer mistakes or biases. In some embodiments, the adjustments on which to base the average or weighted average is set based on the rating of a contributor. This can improve the quality of the data-mining because the accounting adjustments of a more highly rated contributor is probably closer to the economic truth. Rating of a contributor will be explained later.

A simple average of a metric without consideration of the ratings of the contributors is computed as follows:

$$\overline{Q} = \frac{Σ {Q}_{i}}{n}$$

The weighted average of a metric based on the ratings of contributors will be as follows:

$$\overline{Q} = \frac{Σ {Q}_{i} \times {R}_{i}}{Σ {R}_{i}}$$

Where Q is the weighted average metric and Rᵢ is the rating for the contributer that contributed metric Qᵢ (more highly rated contributers have higher Rᵢ).

In some embodiments, certain adjusted financial metrics are calculated by the system 10 (e.g., automatically). These include Net Operating Profit After Taxes (sometimes known as NOPLAT or NOPAT in the literature) 118 and Invested Capital 98.

In some embodiments, another step in performing financial analysis is studying the performance of a company historically and also compared to its peers.

In various embodiments, the graphs used to perform historical and peer analysis are drawn automatically based on (are drawn in response to) the accounting numbers, accounting adjustments and adjusted financial metrics described above, for example.

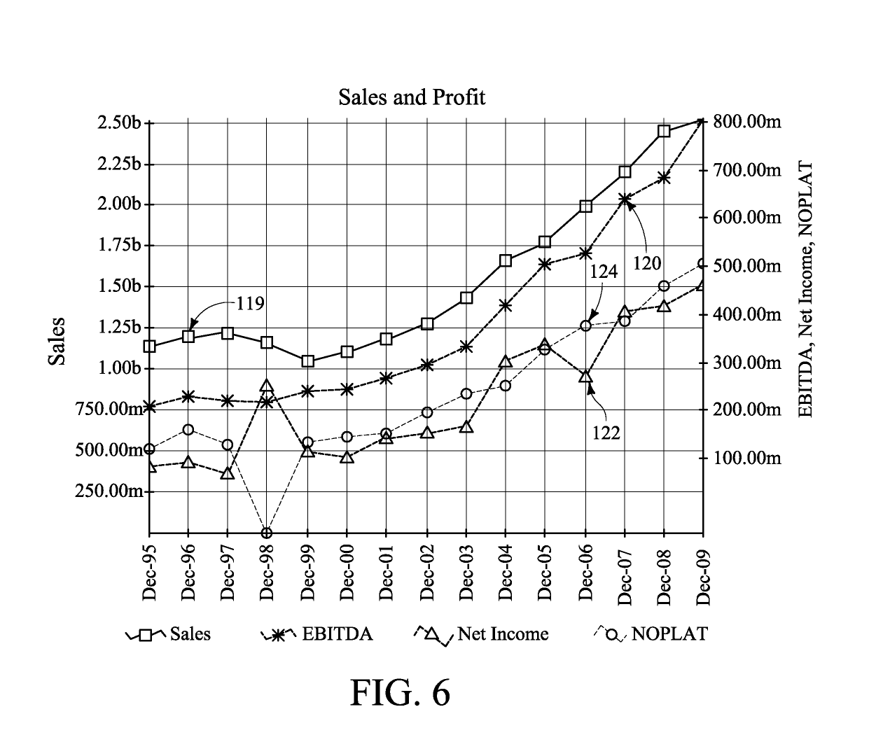

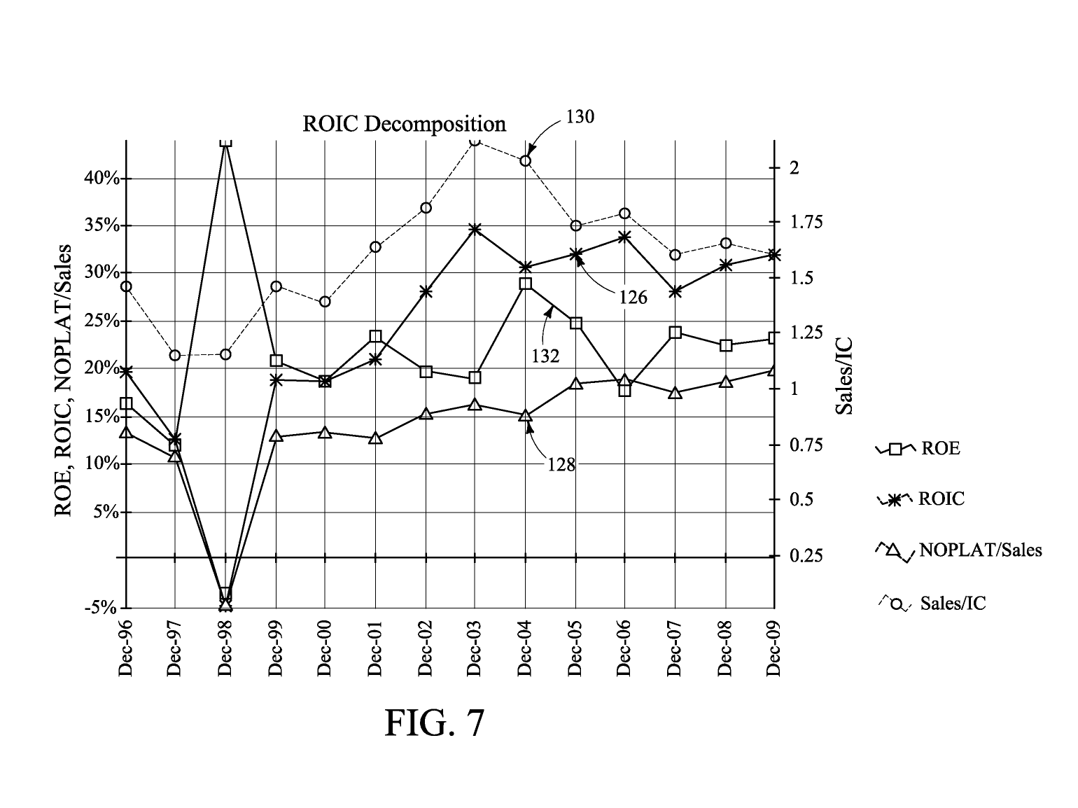

FIGS. 6-10 show graphs, various combinations of which are created (e.g., automatically) in various embodiments. These graphs help a contributor perform an analysis but at the same time become part of the rich write-up automatically.

FIG. 6 illustrates, for a company, how Sales 119, EBITDA 120, Net Income 122, and Net Operating Profit After Tax (NOPLAT) 124 change over time. Growth rate is a useful input in determining a stock price. Different symbols or colors can be used to distinguish between Sales, EBITDA, Net Income, and Net Operating Income in various embodiments.

FIG. 7 illustrates Return on Invested Capital (ROIC) decomposition for a company. More particularly, FIG. 7 shows how Return on Invested Capital 126 changes over time and how ROIC is broken down by Net Operating Income After Tax Margin (NOPLAT/Sales) 128, and Invested Capital Turnover (Sales/IC) 130. Return on Equity (ROE) 132 is also shown in the illustrated embodiment.

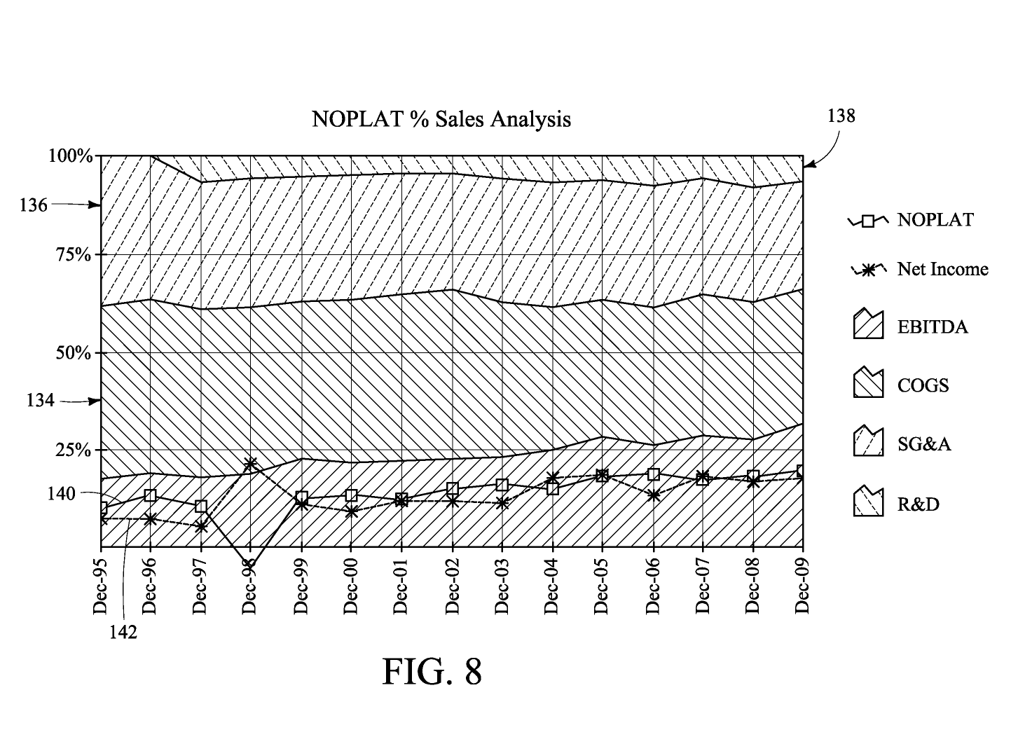

FIG. 8 illustrates the breakdown of Net Operating Income After Taxes Margin (NOPLAT/Sales) by Cost of Goods Sold (COGS) 134, Sales, General and Administrative (SG&A) 136, and Research and Development (R&D) 138. This graph illustrates visually what is typically learned by looking at numbers in a spreadsheet. While cross-hatches are shown in various of the figures, in various embodiments, colors, symbols, or other means are used to distinguish different portions of breakdown graphs. In various embodiments, NOPLAT 140 and net income 142 are also shown on the graph. FIG. 8 shows if the profitability of a company has changed over time and if so, what costs have changed.

While cross-hatches are shown in various of the figures, in various embodiments, colors, symbols, or other means are used to distinguish different portions of breakdown graphs.

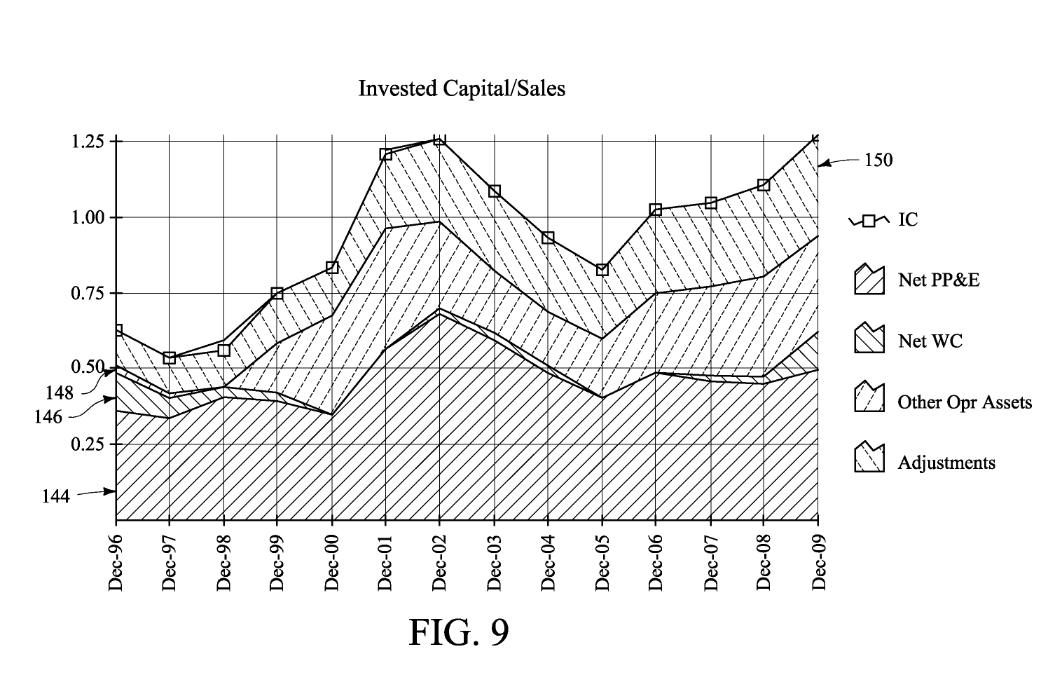

FIG. 9 illustrates the breakdown of Invested Capital/Sales by Plant Property & Equipment (Net PP&E) 144, Working Capital (Net WC) 146, Other Operating Assets (Other Opr Asset) 148, and Adjustments 150. This graph illustrates visually what is typically learned by looking at numbers in a spreadsheet. This graph shows relative to the sales of a company, how its Invested Capital and the components of the latter have changed over time. It is used to diagnose if a company has idle working capital, plant equipment and others.

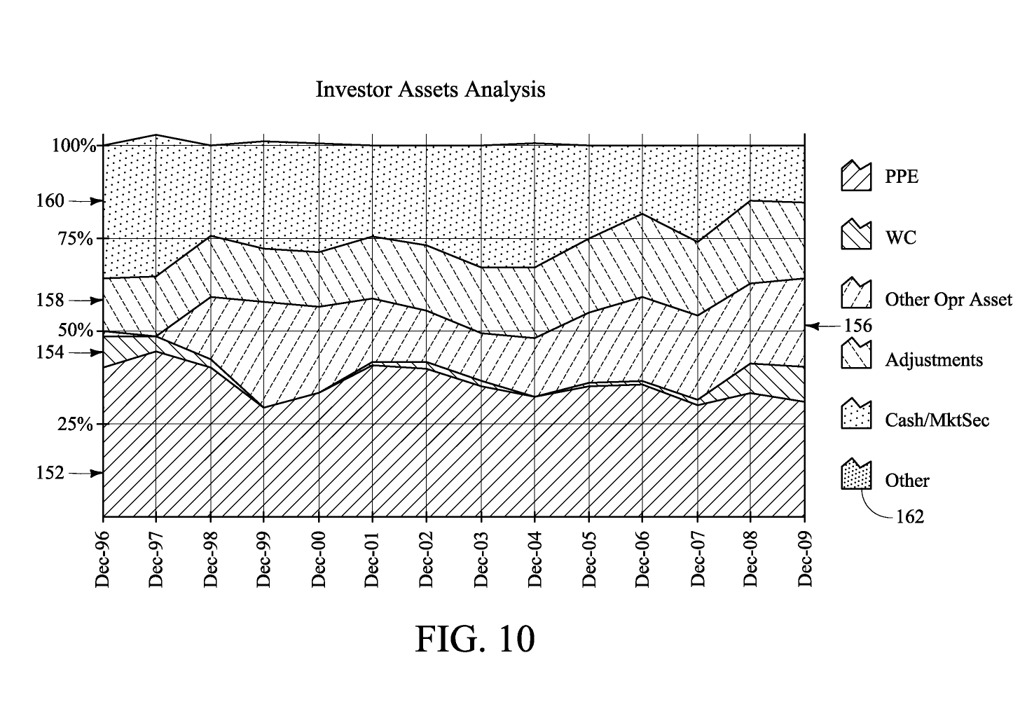

FIG. 10 illustrates the breakdown of investor assets by its components: Plant Property & Equipment (PPE) 152, Working Capital (WC) 154, Other Operating Assets (Other Opr Asset) 156, Adjustments (Adj) 158, Cash and Marketable Securities (Cash/MktSec) 160 (if any) and Others 162 (if any—none in FIG. 10). This graph illustrates visually what is typically learned by looking at numbers in a spreadsheet. It helps diagnose if a company has been accumulating unused cash.

The equations used to calculate the values in these graphs are based on the accounting numbers, accounting adjustments and adjusted financial metrics. The format in which the underlying data is stored is standardized, hence enabling these graphs to be drawn automatically and consistently across write-ups by different contributors.

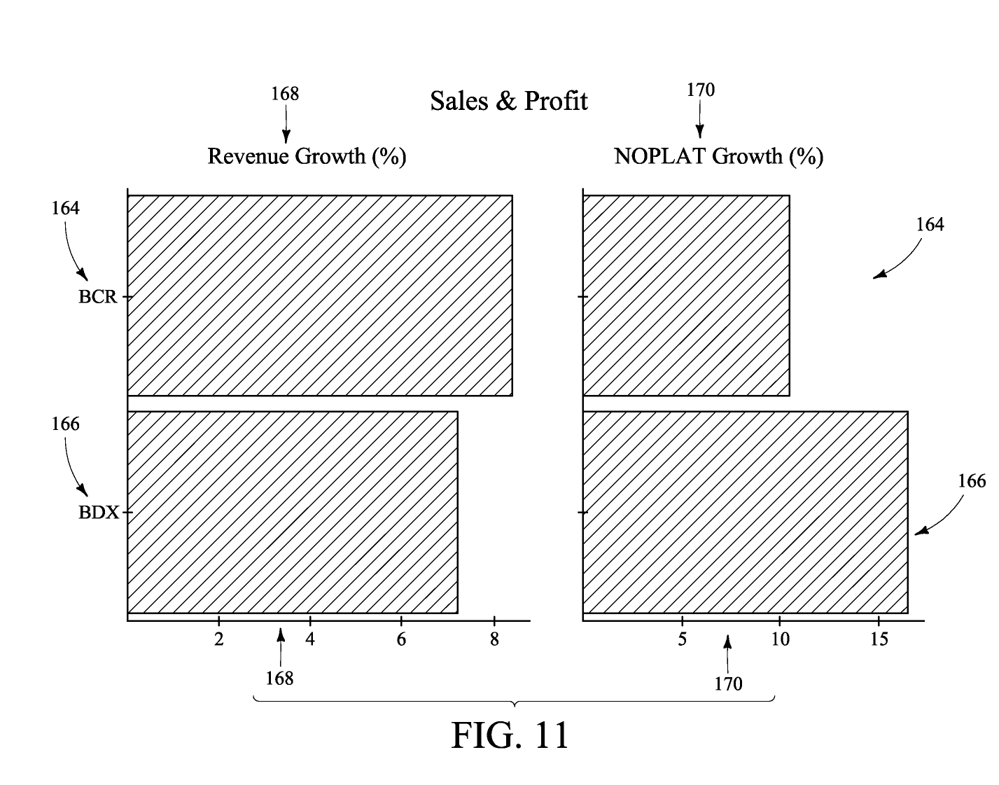

FIGS. 11-15 show graphs generated by the system 10, and correspond to FIGS. 6-10, respectively, but show comparisons between companies, funds, countries, or other entities. These graphs are also automatically created, in various embodiments. These graphs help a contributor understand a company's performance compared to other companies in the same field (peers). At the same time, these graphs are part of the rich write-up automatically, in various embodiments.

FIG. 11 is a graph comparing companies, mutual funds, user-designed funds, countries, or other types of entities 164 and 166 for growth such as revenue growth 168 and NOPLAT growth 170, in accordance with various embodiments. Other comparisons are possible. While FIG. 11 shows two entities (companies, in the illustrated embodiment) being compared, more than two entities are compared in other embodiments.

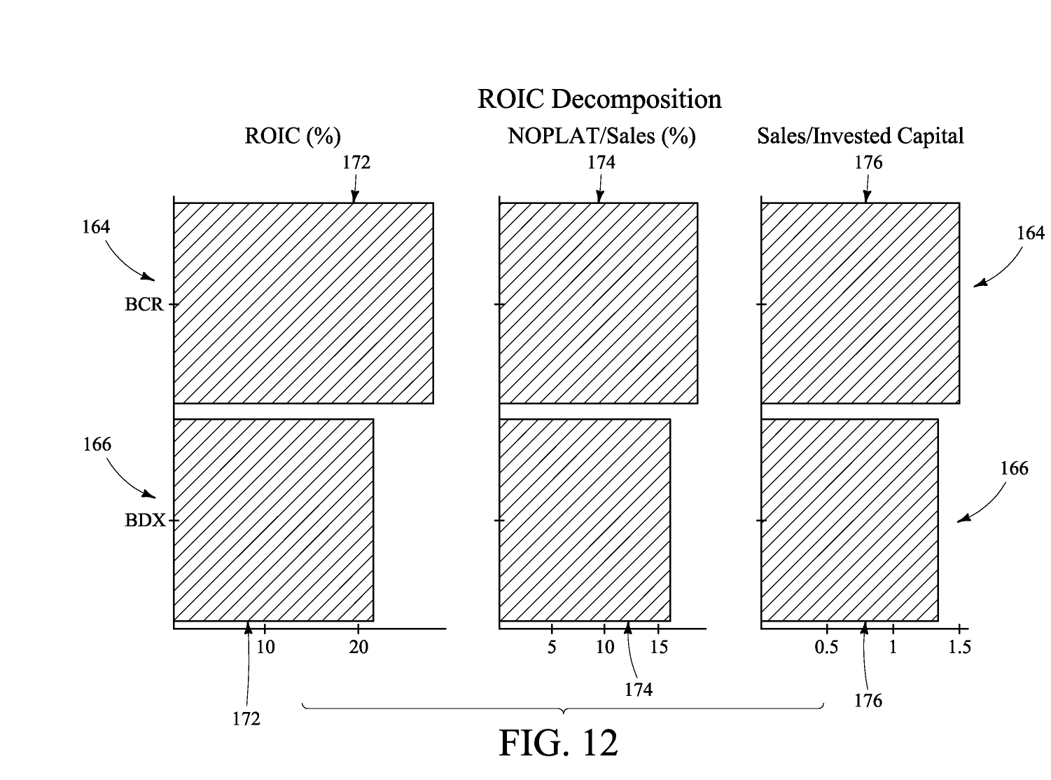

FIG. 12 is a graph comparing companies, funds, or other types of entities 164 and 166 for Return on Invested Capital 172, in accordance with various embodiments. In the illustrated embodiment, NOPLAT/Sales (%) 174 and Sales/Invested Capital 176 are also compared. Other comparisons are possible. While FIG. 12 shows two entities being compared, other numbers of comparisons are possible.

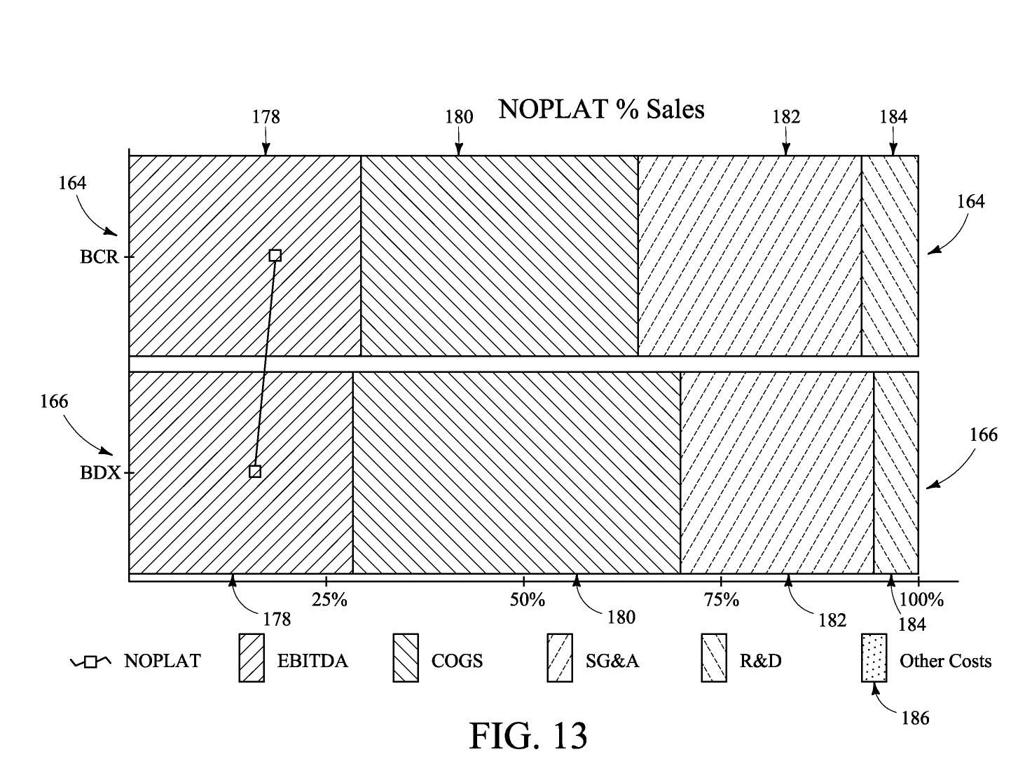

FIG. 13 is a graph comparing two companies, funds, or other types of entities 164 and 166 for breakdown of Net Operating Income After Taxes Margin (NOPLAT/Sales) by EBITA 178, Cost of Goods Sold (COGS) 180, Sales, General and Administrative (SG&A) 182 and Research and Development (R&D) 184 and other costs 186 (if any), in accordance with various embodiments.

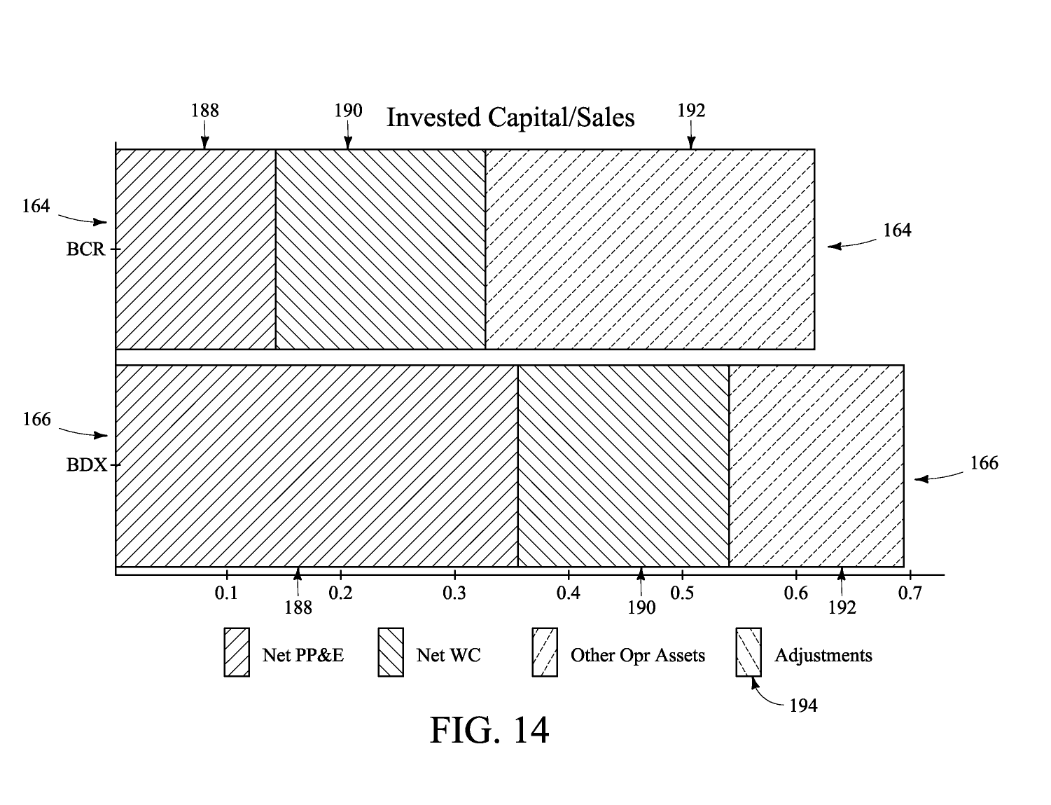

FIG. 14 is a graph comparing two companies, funds, or other types of entities 164 and 166 for breakdown of Invested Capital per Sales by Plant Property & Equipment (PP&E) 188, Working Capital (WC) 190, Other Operating Assets (Other Opr Asset) 192, and Adjustments (Adj) 194 (if any), in accordance with various embodiments.

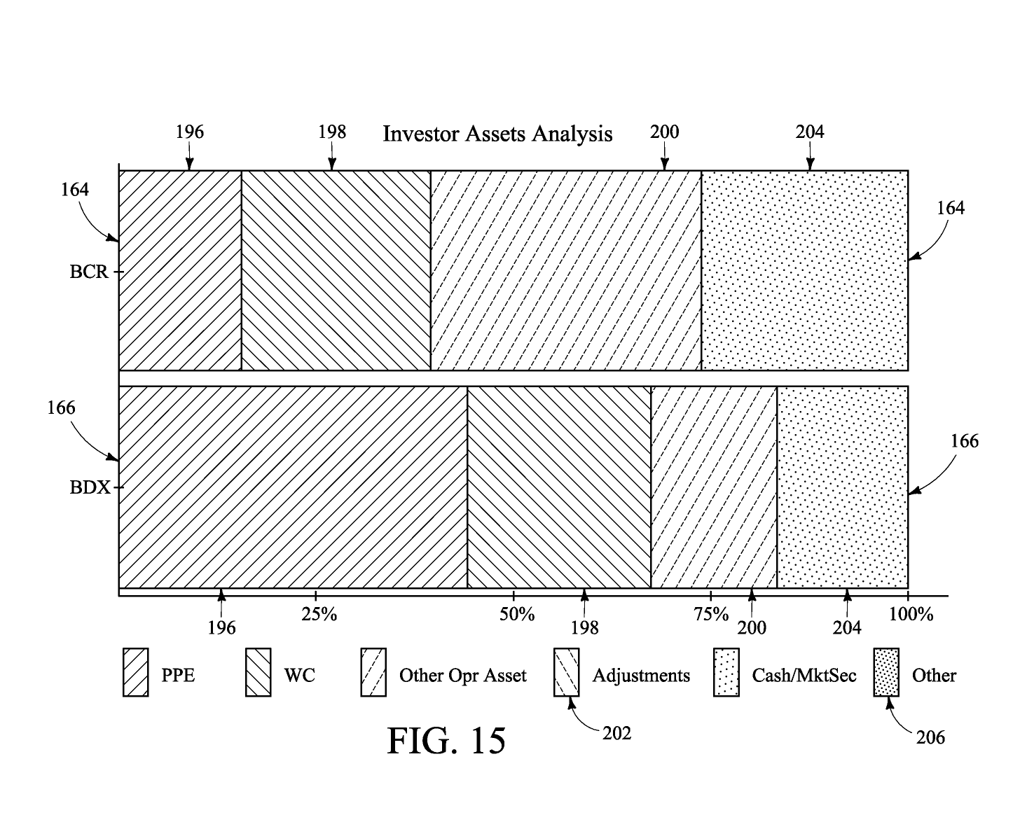

FIG. 15 is a graph comparing two companies, funds, or other types of entities 164 and 166 for breakdown of investor assets by Plant Property & Equipment (PP&E) 196, Working Capital (WC) 198, Other Operating Assets (Other Opr Asset) 200, Adjustments (Adj) 202 (if any), Cash and Marketable Securities (Cash/MktSec) 204 and Others 206 (if any), in accordance with various embodiments.

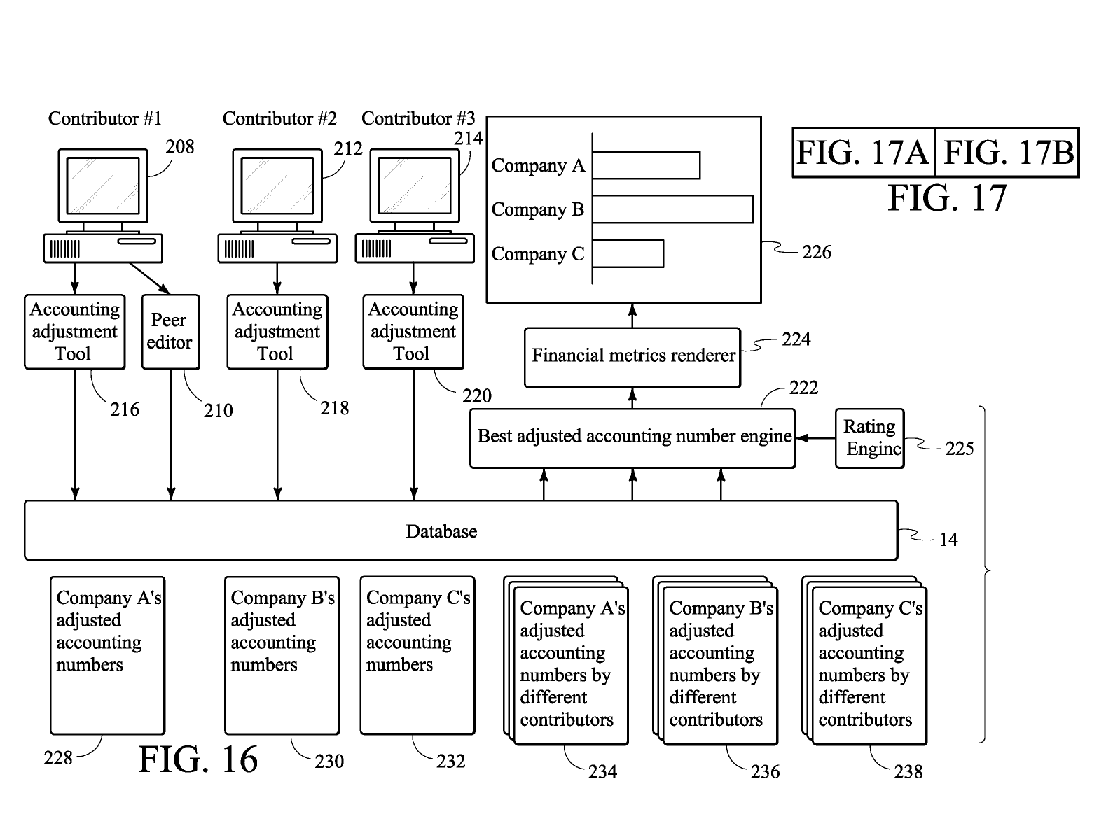

Normally, analyses of different companies are done in separate spreadsheets that are not linked. As a result, the work needed to create FIGS. 11-15 is normally a laborious process because data need to be collected from disparate sources. On the other hand, in the illustrated embodiments, all that is required is for the contributor to pick, using a client or terminal 208 (see FIG. 16), the peer company to which another or other companies are to be compared, using peer editor 210. Then the appropriate accounting numbers (see FIG. 5A), accounting adjustments and adjusted financial metrics are automatically pulled from write-ups contributed by other contributors who used clients or terminals 212 and 214, for example. A contributor using terminal 208 working on a write-up for a company need not have worked on another write-up for another peer company in order to perform this peer analysis. The system 10 uses the write-up from another contributor. Different contributors, using terminals 208, 212, and 214, will have provided accounting adjustments for various companies or other types of entities using accounting adjustment tools 216, 218, and 220 of the system 10. The accounting adjustments are stored in the database 14.

This is process is illustrated in FIG. 16. In some embodiments, a “best adjusted accounting numbers” engine 222 computes the weighted average of the contributed adjusted accounting numbers, using rating engine 225, as follows:

$$\overline{Q} = \frac{Σ {Q}_{i} \times {R}_{i}}{Σ {R}_{i}}$$

where Q is the weighted average metric and Ri is the rating for the user that contributed a metric Qi. Such ratings computed by the system 10. Metric Qi can be for example, Revenue, Income, Assets, or some other financial metric from a financial statement that merits adjusting. Using the best adjusted accounting numbers from engine 222, financial metrics renderer 224 can render graphs 226, as described herein, using adjusted financial metrics taking into account adjustments from multiple contributors. Adjusted accounting numbers 228, 230, and 232 from a contributor using terminal 208, for different companies Company A, Company B, and Company C, are stored in the database 14. Different adjusted accounting numbers from different contributors are stored in the database 14 for respective companies (see sets 234, 236, and 238 of adjusted accounting numbers for companies A, B, and C, respectively).

Yet another difficulty with creating FIGS. 11-15 normally is that the format for the recast financial statements is often different from contributor to contributor. Having a standardized recast financial statement described above makes it possible to draw these graphs in the various embodiments.

A step in developing an analysis is performing further analysis and interpretation of the adjustments and adjusted financial metrics and the graphs drawn.

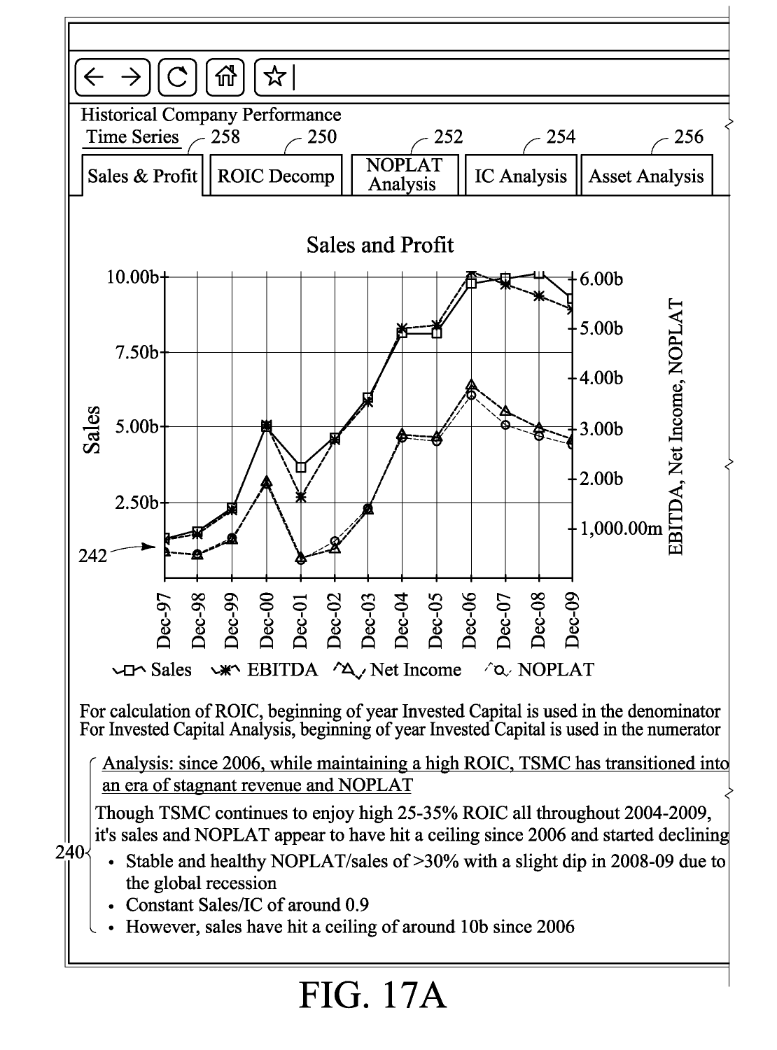

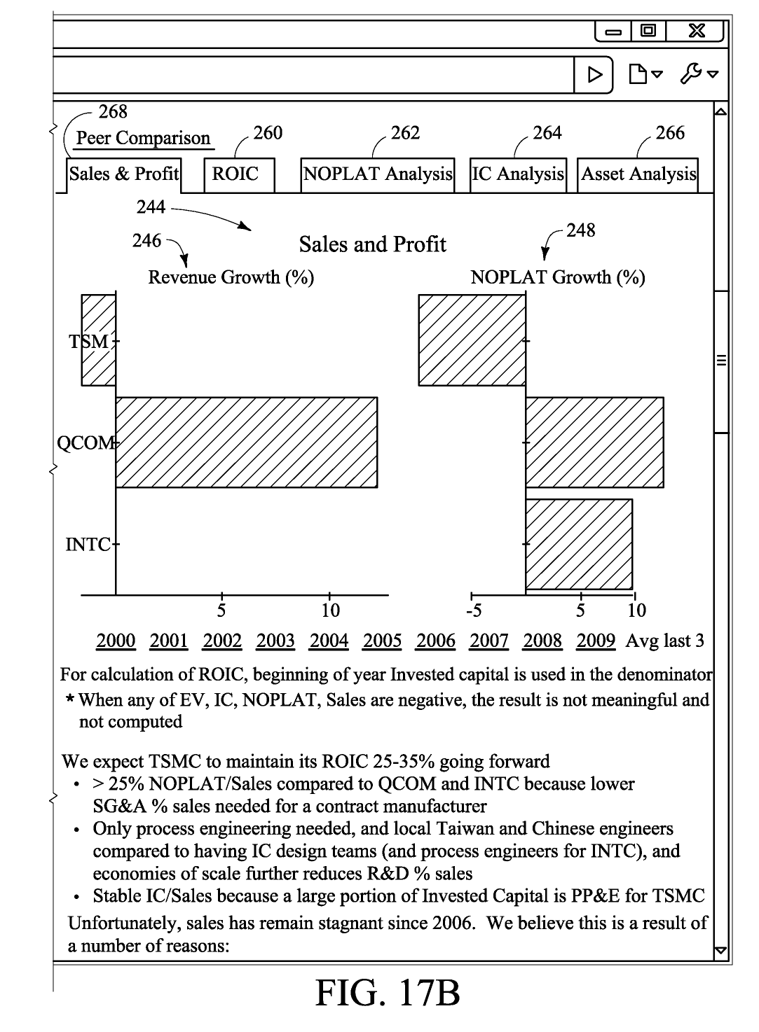

FIGS. 17A-B illustrates how a contributor's commentary 240 is attached to the bottom of graphs 242 and 244 by the system 10, in various embodiments. The graphs can include a graph comparing the company commented on to another company. A contributor uses commentary 240 to provide his written analysis and insights into the graphs 242 and 244. In the illustrated embodiment, specific graphs are shown. However, in some embodiments, commentary can be shown along with any of the graphs of the figures. For example, the graphs 242 and 244 could comprise one, two, or more of any of the following types of graphs: a sales and profit graph (see, e.g., FIGS. 17A and 17B and FIG. 6); an ROIC decomposition graph (see, e.g., FIGS. 7 and 12); a NOPLAT analysis graph (see, e.g. FIGS. 8, 11, and 13); an invested capital analysis graph (see, e.g., FIGS. 9, 10, 14 and 19); and an asset analysis graph (see, e.g., FIG. 15).

More particularly, in the illustrated embodiment, the graph 242 is a graph of EBITDA, Net income, and NOPLAT (or NOPAT) over time, or otherwise indicates sales and profits for the company to which the commentary 240 mainly pertains. In the illustrated embodiment, the graph 244 is a graph comparing percentage revenue growth 246 of various companies, including the company to which the commentary 240 mainly pertains, and comparing NOPLAT growth percentage 248 of the same companies.

The screen shown in FIG. 17A also includes a tab or link 250 which a user can actuate to view Return on Invested Capital decomposition (ROIC decomposition) as shown in FIG. 7, a tab or link 252 which a user can actuate to view a Net Operating Profit Less Adjusted Taxes (NOPLAT) analysis as shown in FIG. 8, a tab or link 254 which a user can actuate to view an Invested Capital analysis (IC analysis) as shown in FIG. 9, a tab or link 256 which a user can actuate to view an asset analysis as shown in FIG. 10, and a tab or link 258 which a user can actuate to return to the view shown in FIG. 17A.

The screen shown in FIG. 17B also includes, for peer comparison, a tab or link 260 which a user can actuate to view ROIC information, a tab or link 262 which a user can actuate to view a NOPLAT analysis, a tab or link 264 which a user can actuate to view an IC analysis, a tab or link 256 which a user can actuate to view an asset analysis, and a tab or link 268 which a user can actuate to return to the view shown in FIG. 17B.

In various embodiments, the commentary 240 is attached to or associated with historical and peer analysis graphs. In various embodiments, all graphs and models come with a commentary. While the example shown for FIGS. 17A-B shows specific graphs, in various embodiments, any of the screens disclosed and shown herein that have graphs or models can also include commentary. In some embodiments, commentary is shown proximate multiple different graphs. In some embodiments, a user is able to toggle through or page though graphs or sets of graphs and the commentary is associated with all such graphs or sets. The commentary is not intended to be linked only to the revenue and profit graph, that is just an example that is shown.

Calculating the valuation of a stock is another step. In various embodiments, this is done using Discounted Cash Flow, Discounted Economic Value Added and others.

In various embodiments, the system 10 has one or more standardized model templates. In some embodiments, the model is embedded the write-up. In some embodiments, the data of the model is stored in the database for easy access, updating and data-mining.

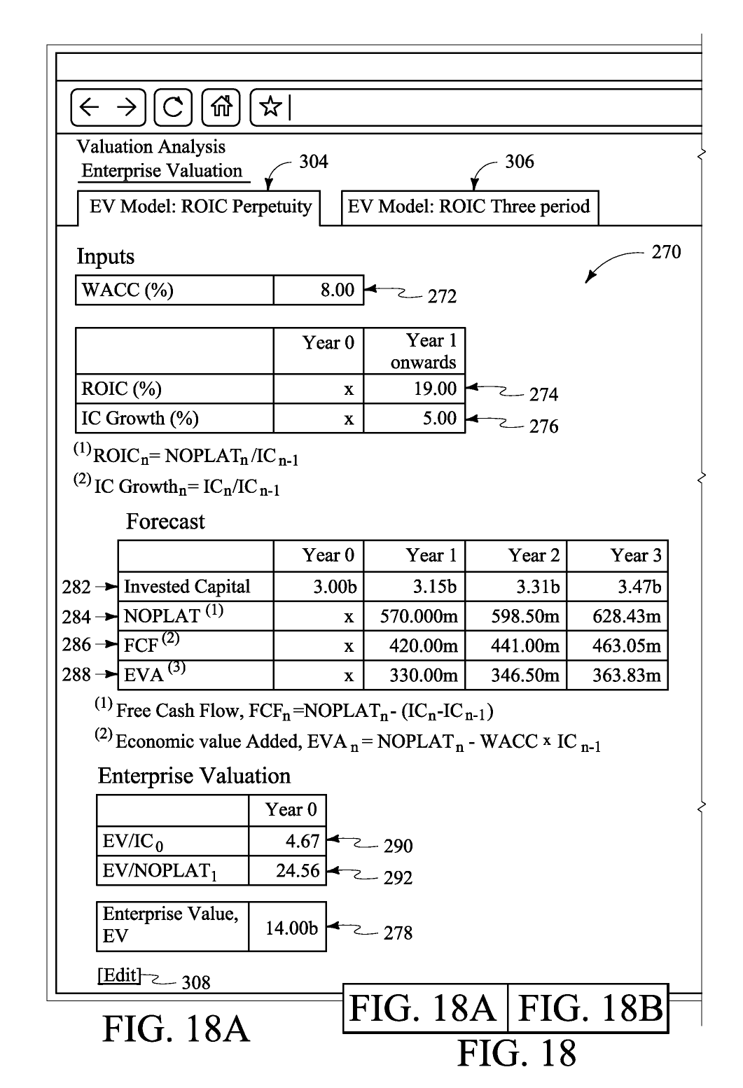

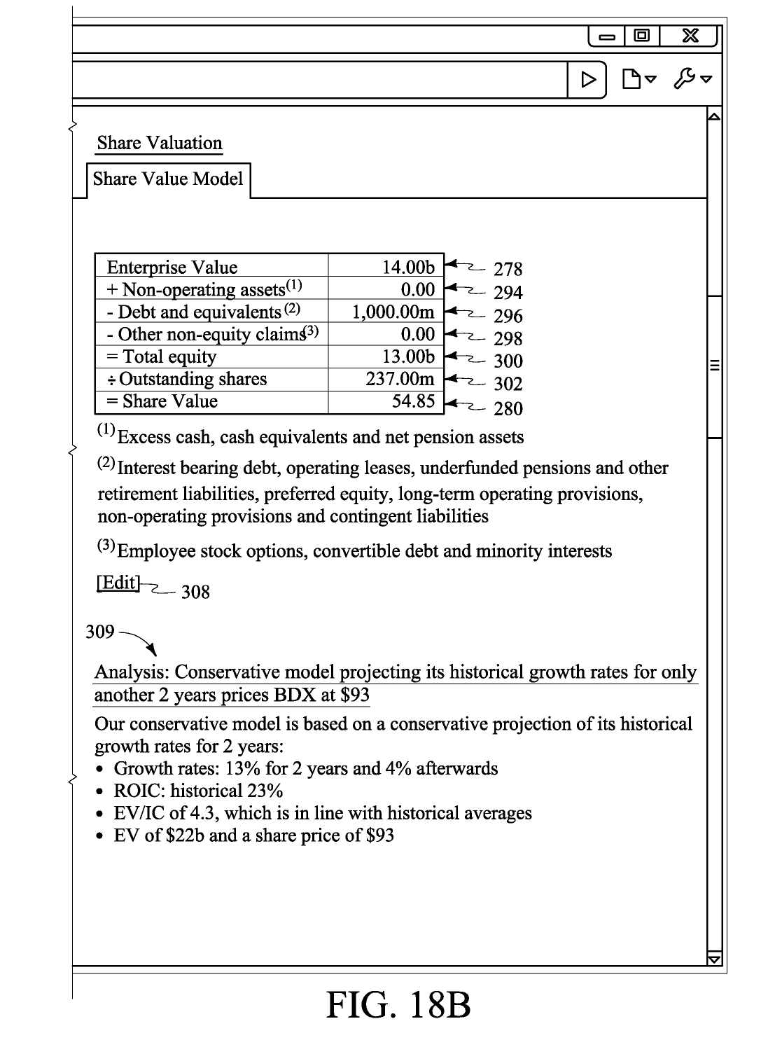

FIGS. 18A-B show a screen-shot of a standardized model template 270, in accordance with some embodiments. Here weighted average cost of capital (WACC) 272, return on invested capital (ROIC) 274, invested capital growth (IC Growth) 276, and invested capital (IC) are inputs, and the system 10 or model computes the Enterprise Value (EV) 278. In this simple example, the Enterprise Value is computed based on a Perpetuity Model. For example, a perpetuity growth model accounts for the value of cash flows that continue into perpetuity in the future, growing at an assumed constant rate.

$$EV = IC \times \frac{ROIC - ICGrowth}{wacc - ICGrowth}$$

Based on the Enterprise Value 278 and other inputs like Debt and equivalents 296 and Number of Outstanding Shares 302, Share Value 280 is computed. In some embodiments, the screen of FIGS. 18A-B also shows forecast invested capital 282, NOPLAT 284, free cash flow 286, and economic value added 288. In some embodiments, the screen of FIGS. 18A-B also show EV/ICO 290 and EV/NOPLAT. In some embodiments, the screen of FIGS. 18A-B also show non-operating assets 294, debt and equivalents 296, other non-equity claims 298, total equity 300, and total outstanding shares 302, in connection with the calculation of Share Value 280. In the embodiment shown in FIGS. 18A-B, the screen also includes tabs, buttons, or links 304 and 306 for switching between an ROIC perpetuity enterprise valuation model and an ROIC three period enterprise valuation model. In some embodiments, one or more edit buttons or links 308 is available which, when actuated, allows a user to edit input numbers or numbers used in calculations, for example.

In various embodiments, the inputs for respective models and write-ups are standardized and stored in the database. This enables comparison of models by different contributors and enables rich data-mining.

Like accounting adjustments, numbers in a model are subjective and dependent on the experience and skill of the contributor. Comparing the models on a standardized format allows a user to make a judgment as to which model is the most accurate.

In some embodiments, data-mining is used to obtain a better model than any of the individually contributed model. Average or median or weighted average of several models have fewer biases than an individual.

One can also select the set of models to base the average or weighted average on, based on the rating of a contributor. This can improve the quality of the data-mining because the model of a more highly rated contributed is probably closer to the economic truth. This is described under Master Write-up.

Data-mining that is performed in various embodiments also comprises calculating the percentage contribution of Free Cash Flow from different forecast periods to the final stock price. Various embodiments standardize the inputs for each model so that this calculation is automatically calculated and comparison can be made across different models by different contributors. This calculation enables a user to understand if a contributor is assuming more aggressive growth in a model compared to another.

FIG. 18B illustrates how a contributor's commentary 309 is attached proximate to, adjacent to or at the bottom of share value and enterprise valuation models by the system 10, in various embodiments. While the commentary 309 is shown in FIG. 18B, in the illustrated embodiment, the commentary can be at the bottom of FIG. 18A, in some embodiments.

Another step in developing an analysis is studying the market valuation of the company historically and also compared to its peers. This study is normally done using spreadsheets. However, in the illustrated embodiments, graphs used to perform historical and peer valuation analysis are drawn automatically based on the historic share prices, accounting numbers, accounting adjustments and adjusted financial metrics described above.

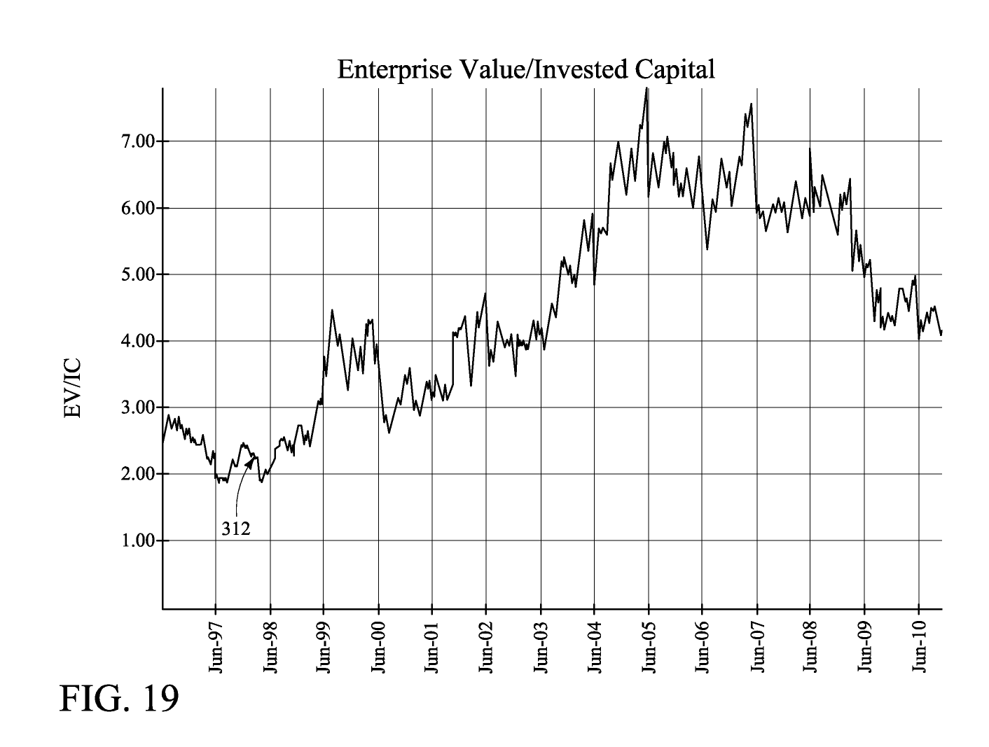

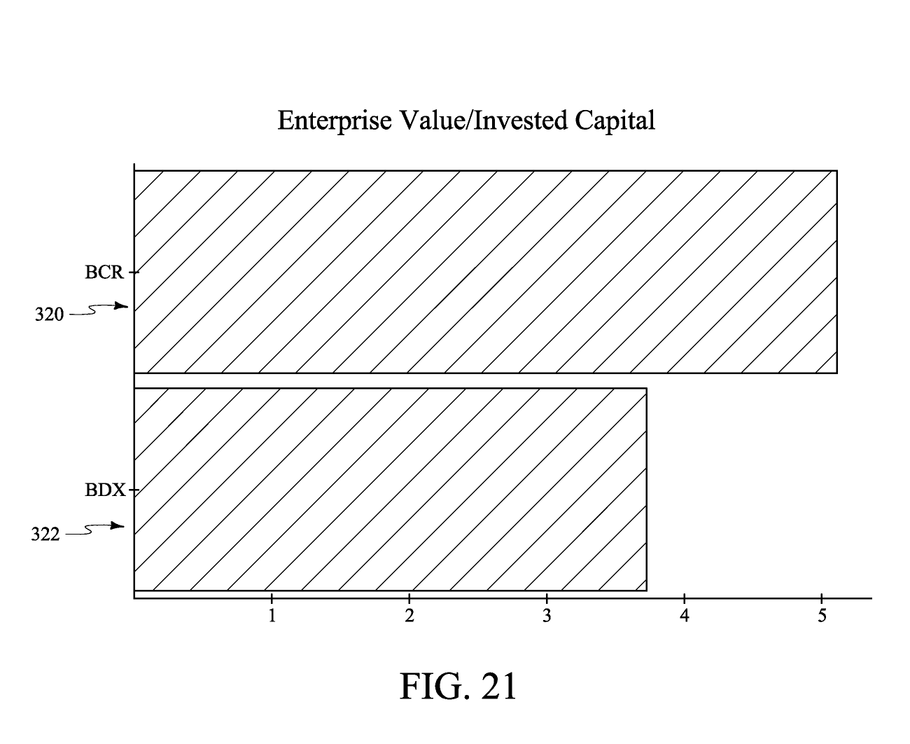

FIGS. 19-22 illustrate example graphs that are drawn by the system 10 (e.g., automatically). The graphs that can be drawn by the system 10 for performing historical and peer valuation analysis are by no means limited to the illustrated graphs and include Enterprise Value to Net Operating Profit After Tax (NOPLAT) Ratio, Price to Earnings Ratio, and others. FIGS. 19 and 21 show the relative valuation of a company with respect to its Invested Capital, historically and compared to its peers. These graphs help indicate if a company's stock is highly valued currently compared to its historical valuation and its peers.

FIG. 19 shows a graph 312 of Enterprise Value divided by Invested Capital versus time.

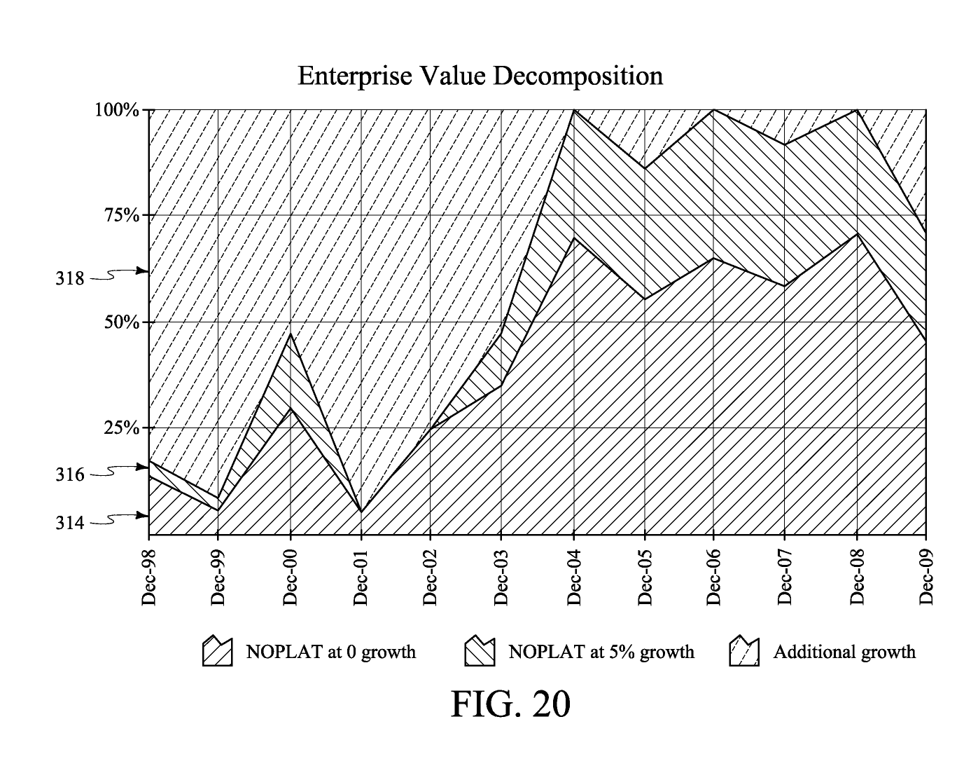

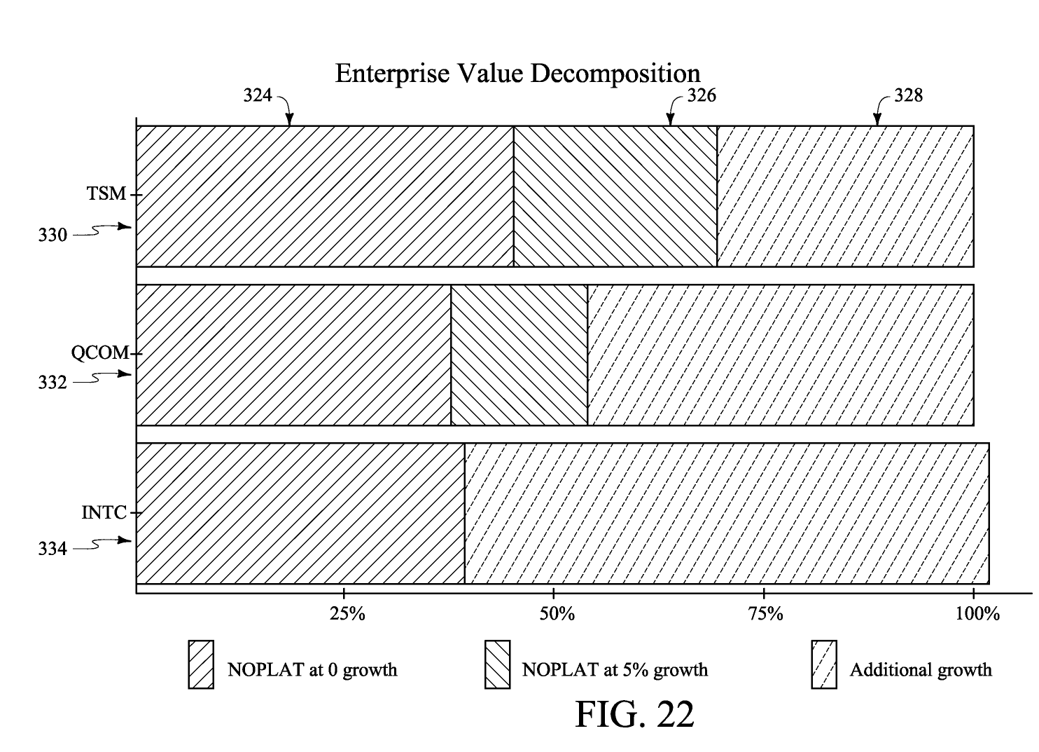

FIGS. 20 and 22 show the breakdown of the Enterprise Value into three parts: (1) Value of the company if it were to continue having the same Net Operating Profit After Tax (NOPLAT or NOPAT) into perpetuity for that year, (2) Additional value of the company if its NOPLAT (or NOPAT) were to grow at 5%, (3) The remaining portion, attributed to NOPLAT (or NOPAT) growth above 5%, if any. These graphs help indicate the amount of growth that is assumed in a company's valuation at various points in history and compared to its peers.

FIG. 20 shows enterprise value decomposed into (1) Value of the company if its NOPLAT continued with zero growth into perpetuity 314, (2) Additional value if its NOPLAT grew at 5% growth 316, and (3) The remaining portion attributed to additional NOPLAT growth beyond 5% 318. Assume that a company makes a certain Net Operating Profit After Tax (abbreviated as NOPLAT or NOPAT). If we assume this to go on forever, the system can calculate a theoretical value for its Enterprise Value, say EV_{—}0. If instead, we assume the company will grow its NOPAT at a growth rate g, and that it will also continue to grow its invested capital at the same growth rate (so the company doesn't have an ROE or ROIC that keeps increasing, something that doesn't exist in reality), then the system can also calculate a theoretical Enterprise Value for such a company EV_g. The enterprise value of the company as valued by the stock market EV is usually neither. If it is much higher than say EV_{—}5, (5 is just chosen to represent GDP, could have been 3 or 6), then this means that the company is expected to grow its NOPAT significantly over the coming years, faster than GDP.

$$EV\_ 0 = \frac{NOPLAT}{wacc}$$

$$EV\_g = \frac{NOPLAT \times ( 1 + g ) \times ( 1 - \frac{g}{ROIC} )}{wacc - g}$$

Enterprise Value decomposition basically has three parts:

(1) EV_{—}0/EV, representing how much of the EV is a company with no growth;

(2) (EV_{—}5−EV_{—}0)/EV, representing how much more (‘more’ than zero growth) of the EV would be accounted for with just 5% growth; and

(3) 100%-(1)−(2) representing how much more of the EV requires more than 5% growth.

A company that has a higher (1) or (1)+(2) value, compared to others or compared to its previous history could be a good value investment. Value (2) also can be used to interpret whether the company is making profits beyond its cost of capital. A company that has a NOPAT that meets stock market expectations; i.e., NOPAT˜IC×WACC, will not be creating additional value and (2)˜0.

FIG. 21 shows Enterprise Value divided by Invested Capital compared for two or more stocks, funds, or other entities 320 and 322.

FIG. 22 shows Enterprise Value Decomposition into (1) Value of the company if its NOPLAT continued with zero growth into perpetuity 324, (2) Additional growth if its NOPLAT grew at 5% growth 326, and (3) The remaining portion attributed to additional NOPLAT growth beyond 5% 328 compared between multiple stocks, funds, or other entities 330, 332, and 334.

Normally, analyses of different companies are done in separate spreadsheets that are not linked. Using the system 10 to create Error! Reference source not found.-22 avoids a traditionally laborious process where data is collected from disparate sources.

Various embodiments allow a contributor to revise his/her own write-up or that of others. New and old versions of write-ups are maintained so that users can reference the old ones if desired and to give recognition to old write-ups that have been revised and their contributors.

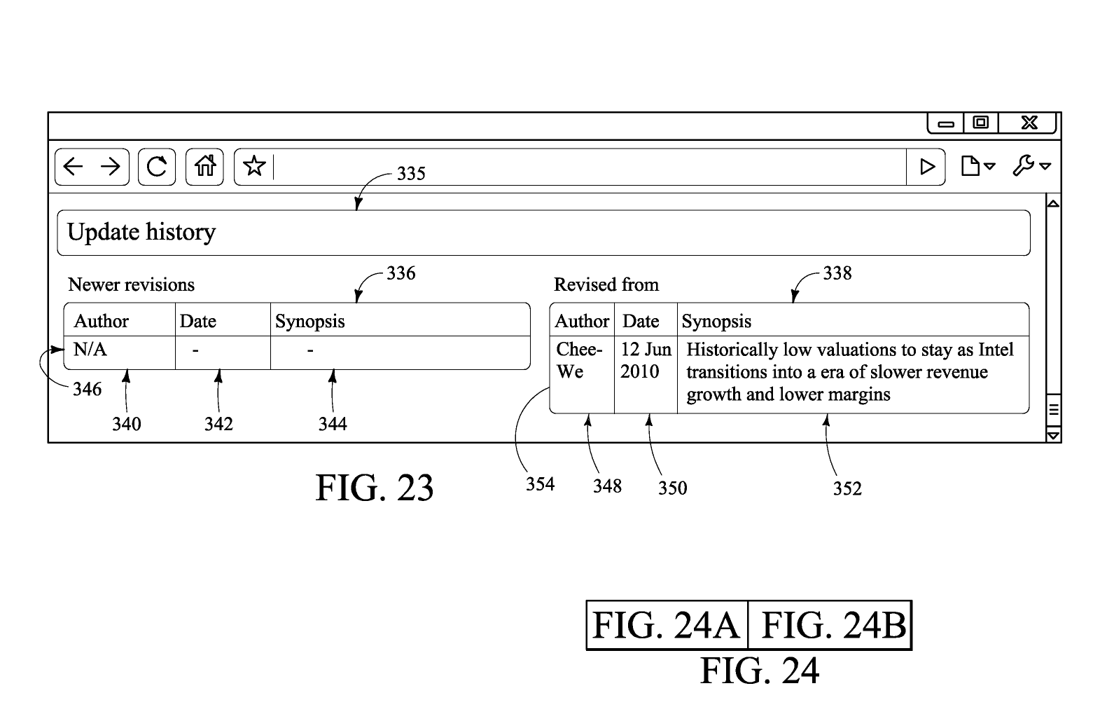

FIG. 23 shows an update history 335. In the illustrated embodiment, the update history 334 includes a table listing, on one side 336, later write-ups that have been created based on revising the current write-up. In the illustrated embodiment, the side 336 shows author 340, date 342, and synopsis 344 for newer revisions 346, if any. The other side 338 shows write-ups that this current write-up is based on. In the illustrated embodiment, the side 338 shows author 348, date 350, and synopsis 352 for an earlier write up 354. Other details or arrangements can be shown in other embodiments.

Various embodiments allow contributors to update write-ups. Write-ups can be revised concurrently by multiple contributors. Yet the original contributors have their credit recognized in the revision history tables.

With multiple write-ups of a single topic by different contributors, it is useful to create a single master write-up for each topic. In some embodiments, the system 10 creates this master write-up by consolidating the commentary under each section or tool.

The master write-up computes a prediction of the price of a security based on the valuations in each write-up. This prediction is calculated using, for example, a simple average of the price Pi in each write-up.

$$\overline{P} = \frac{Σ {P}_{i}}{n}$$

In other embodiments, the prediction can be calculated using a weighted average taking into account the ratings of the contributors Ri:

$$\overline{P} = \frac{Σ {P}_{i} \times {R}_{i}}{Σ {R}_{i}}$$

In various embodiments, other metrics can also aggregated automatically, such as, for example, median of the prices Pi; 90% statistical confidence interval for the prices; number of buys; and number of sells.

By having multiple write-ups, including the recommendation and valuation models stored in the database in a standardized way, the above metrics can be calculated quickly.

These are used, in some embodiments, as an indication of how strongly the contributors believe a certain stock should be a buy.

In some embodiments, the master write-up displays the average of the adjusted accounting numbers and valuation models, as described in the previous paragraphs, using, for example, a simple average

$$\overline{Q} = \frac{Σ {Q}_{i}}{n}$$

In other embodiments, a weighted average is used

$$\overline{Q} = \frac{Σ {Q}_{i} \times {R}_{i}}{Σ {R}_{i}}$$

By aggregating the models of the same template of the various contributions into one, one can get the best estimates of the inputs and the models will calculate a best estimate of the stock price based on these inputs.

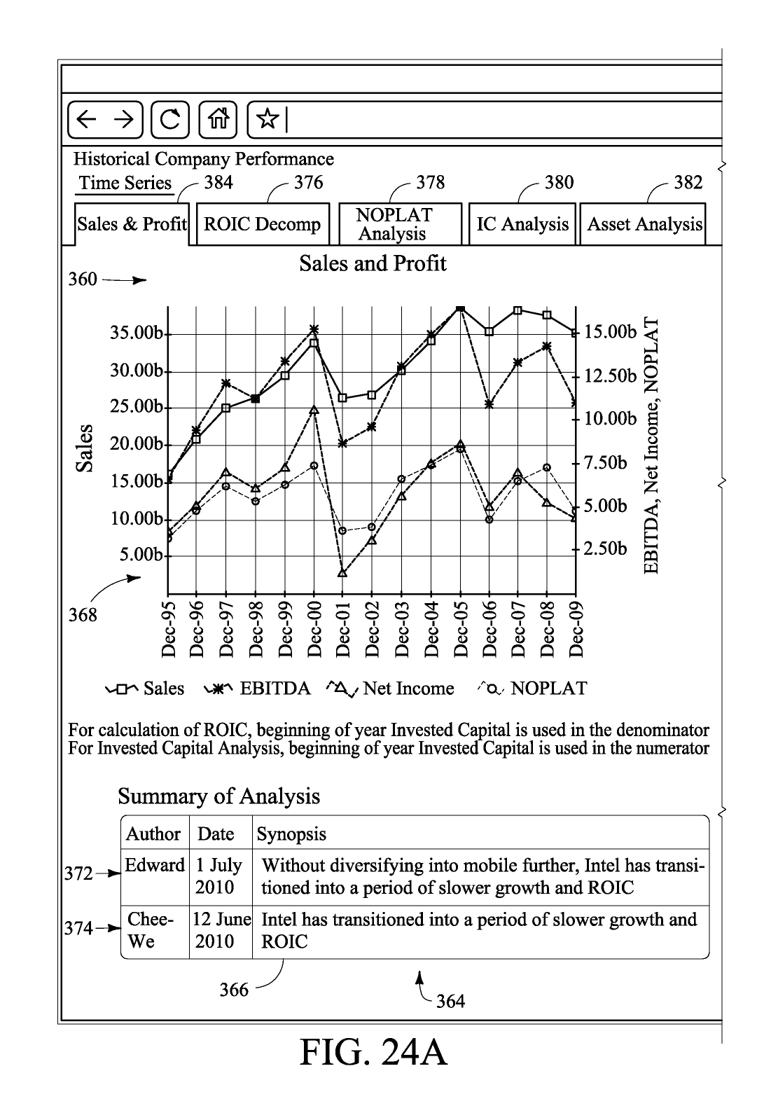

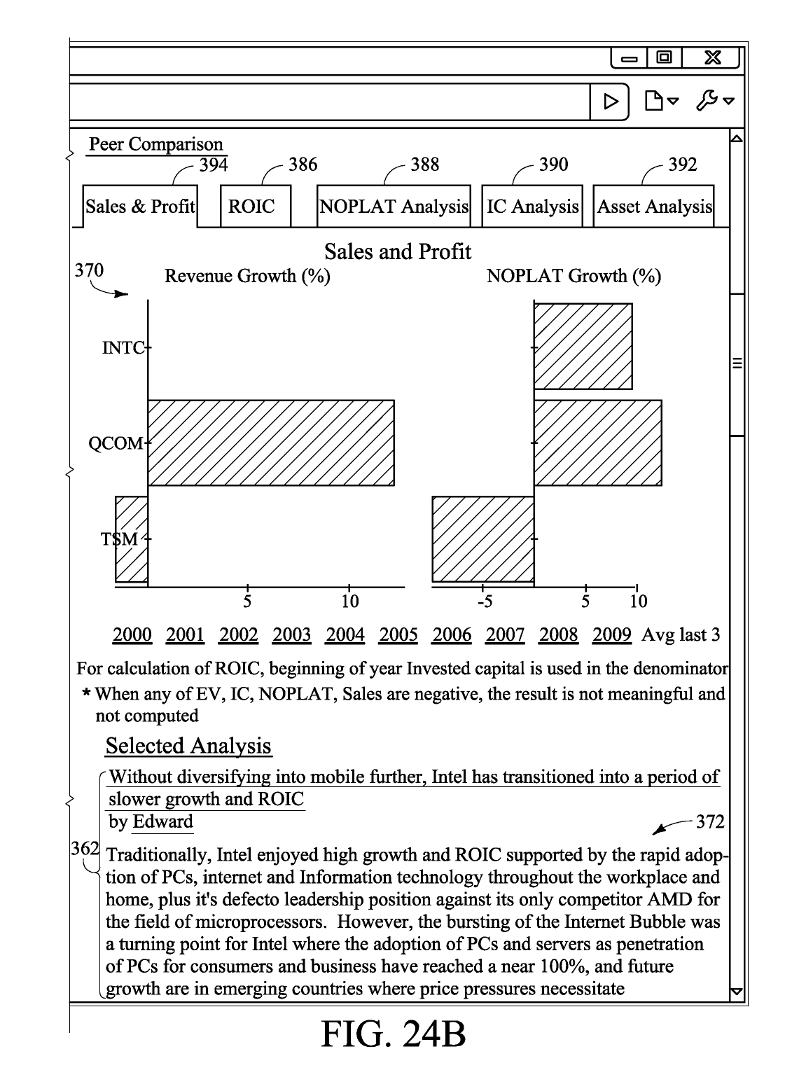

FIGS. 24A-B illustrate a section of a master write-up 360, where commentary 362 has been consolidated by section. One side 364 or portion of the screen shows a table 366 of different commentary related to graphs 368 and 370. A side or portion 372 of the screen abstracts the various commentary related to the set of graphs. In the illustrated embodiment, a user may read and compare commentary against this set of graphs by clicking on different rows 372 and 374 of the table 366. As is the case in other figures, tabs, links, or buttons

The benefits of this are that it allows the user to start with a single page that branches out to the individual write-ups; provides the user with a standardized overview of the topic by sections; and allows the user to compare commentaries related the same tool or section by different contributors.

The screen shown in FIG. 24A also includes a tab or link 376 which a user can actuate to view ROIC decomposition, a tab or link 378 which a user can actuate to view a NOPLAT analysis, a tab or link 380 which a user can actuate to view an IC analysis, a tab or link 382 which a user can actuate to view an asset analysis, and a tab or link 384 which a user can actuate to return to the view shown in FIG. 24A.

The screen shown in FIG. 24B also includes, for peer comparison, a tab or link 386 which a user can actuate to view ROIC decomposition, a tab or link 388 which a user can actuate to view a NOPLAT analysis, a tab or link 390 which a user can actuate to view an IC analysis, a tab or link 392 which a user can actuate to view an asset analysis, and a tab or link 394 which a user can actuate to return to the view shown in FIG. 24B.

Developing ratings for contributors is one way to increase the trust of the users in the content. In some embodiments, the rating of a contributor is based on one or more of: average rating of the contributor's write-ups; number of write-ups from the contributor; number of distinct users that have viewed the write-ups from a contributor over a period of time; number of users subscribing to the contributor's write-ups; number of revisions that is based on the contributor's write-ups; and number of awards.

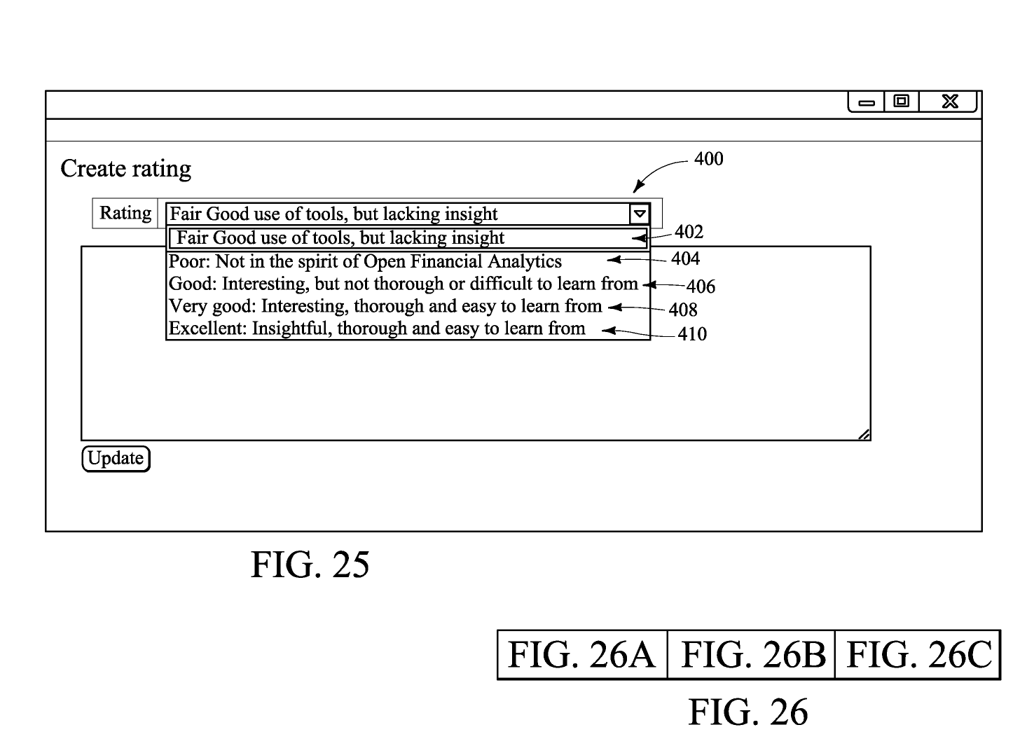

FIG. 25 illustrates one way that contributors may be rated. When viewing a contributor's write-up, a user can select from multiple options, such as by using a pull down menu 400 having alternatives such as Fair 402, Poor 404, Good 406, Very good 408, and excellent 410. Other rating systems and interfaces are possible, such as allowing users to click on a selected number of stars. While five alternatives for ratings are shown in FIG. 25, other numbers of alternatives are possible.

The ratings of contributors are used in various ways, in various embodiments. A user can select to read write-ups by only contributors that have reached a certain rating. In some embodiments, ratings are used as weights for obtaining the best price prediction, as previously described. In some embodiments, ratings are used as weights for obtaining the best accounting adjustments and the best valuation models. Rating are used for providing incentives for contributors in various embodiments.

For weights for obtaining the best price prediction, best accounting adjustments and valuation models, the average rating of all the contributor's write-ups, as rated by the users, is used by the system 10 as the best weight in some embodiments. The average rating of a particular write-up, as rated by all the users. is used in other embodiments. For selecting contributors, any combination of the above rating types can be employed. How ratings are used to compute incentives for contributors is explained later.

In some embodiments, a write-up has a mandatory metric that the contributor must fill in, which is expectation of the stock price. In some embodiments, a contributor must also specify a recommendation (buy, hold or sell) in a write-up.

Based on this set of expected stock prices, a user can generate, using the system, a ranking of stocks to purchase by ranking the list of stocks with write-ups in decreasing order: 1. percentage difference between the average expected stock price and the current stock price, subject to a minimum number of write-ups for each stock; 2. percentage difference between the average expected stock price and the current stock price, divided by the standard deviation of the expected stock prices; 3. percentage difference between the average expected stock price and the current stock price, subject to a minimum number of write-ups for each stock and a minimum rating of the contributor; 4. percentage of buys; and 5. weighted average of 1 through 4 above, for example.

The system 10 collects expected stock prices across different write-ups and has a rating mechanism for the contributors of the write-ups.

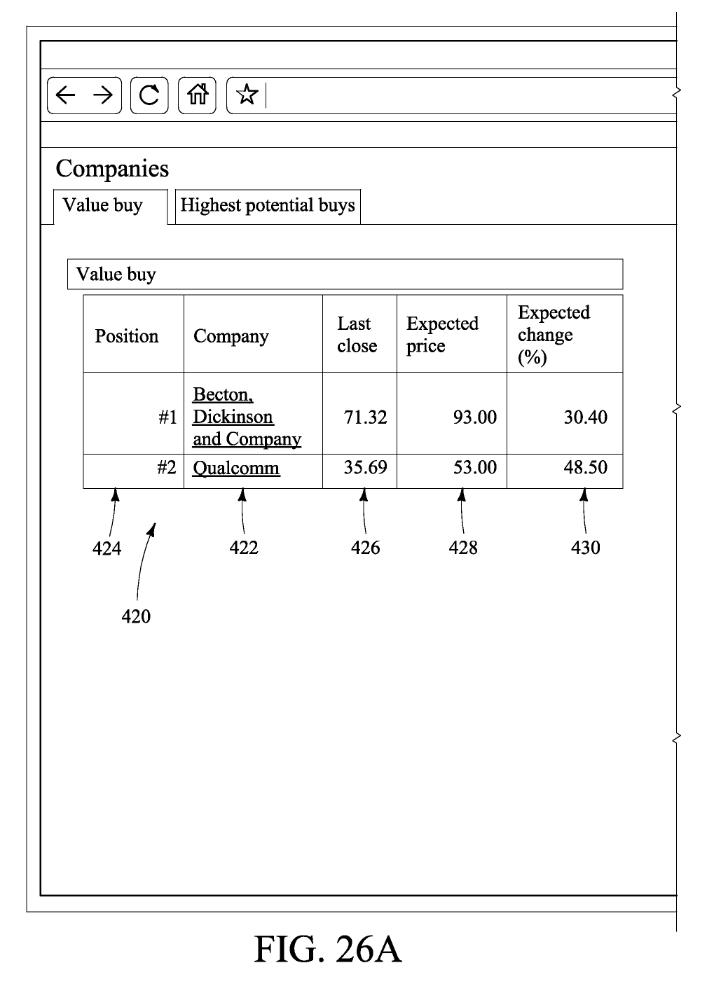

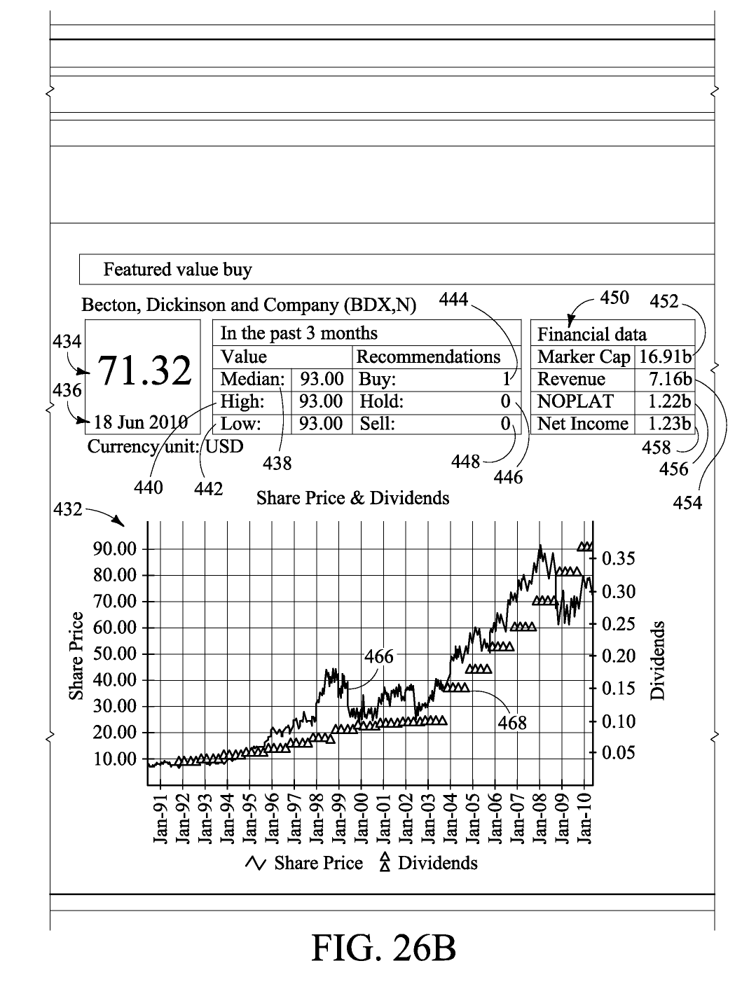

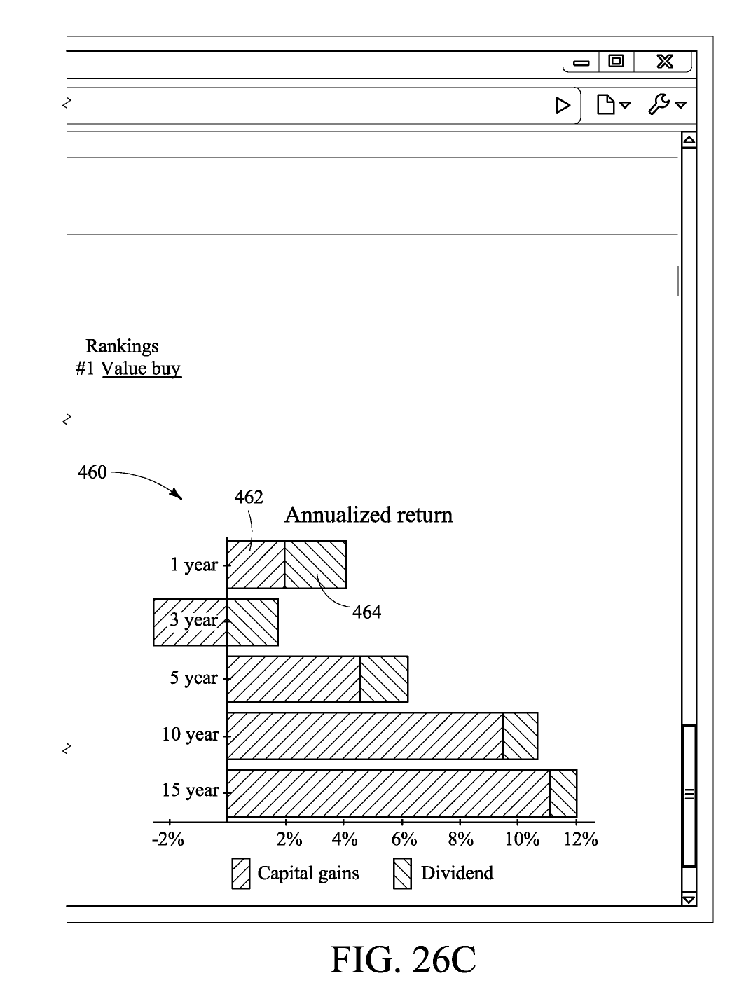

FIGS. 26A-C provide a screen shot on a ranking 420 of companies. Given that the database 16 has significant information about companies (revenue, market capitalization, historical growth rates, industry type, dividend history), the platform or system 10, in some embodiments, generates ranking of companies by different criteria, thereby satisfying a users preference on which type of company to invest in (size, industry, growth, etc.). In the illustrated embodiment, the ranking 420 includes a list of companies 422, the position 424 of each, the last closing price 426 of each, an expected future price 428, and expected change 430. More, less or other information is provided in alternative embodiments. In some embodiments, the screen of FIGS. 26A-C also includes, for a featured company, such as the highest ranked company in the ranking 420, a graph 432; a graph 460; price information 434, date 436 of the price; median, high, and low price predictions 438, 440, and 442; number of buy, hold, and sell recommendations 444, 446, and 448; and financial data 450 such as market capitalization 452, revenue 454, NOPLAT 456, and net income 458. The amount or type of information provided for a featured company varies in alternative embodiments. In the illustrated embodiment, the graph 432 for the featured company shows both share price 466 and dividends 468 on a common axis. In the illustrated embodiment, the graph 460 for the featured company shows both capital gains 462 and dividends 464 on a common axis. More, less, or other graphs are possible.

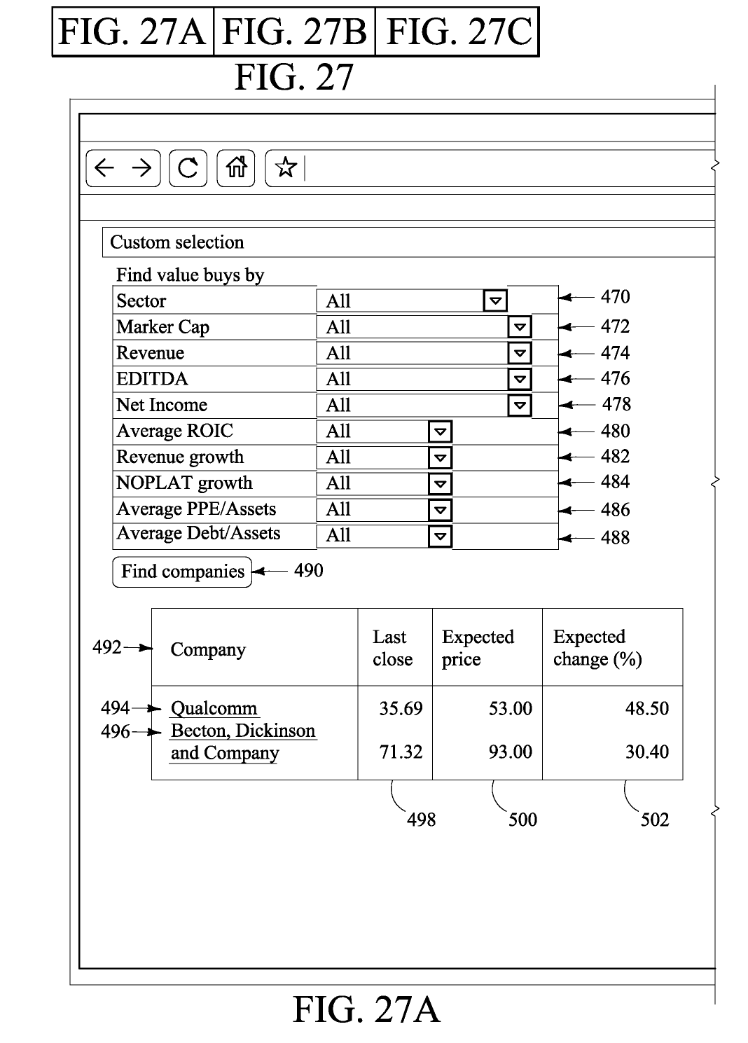

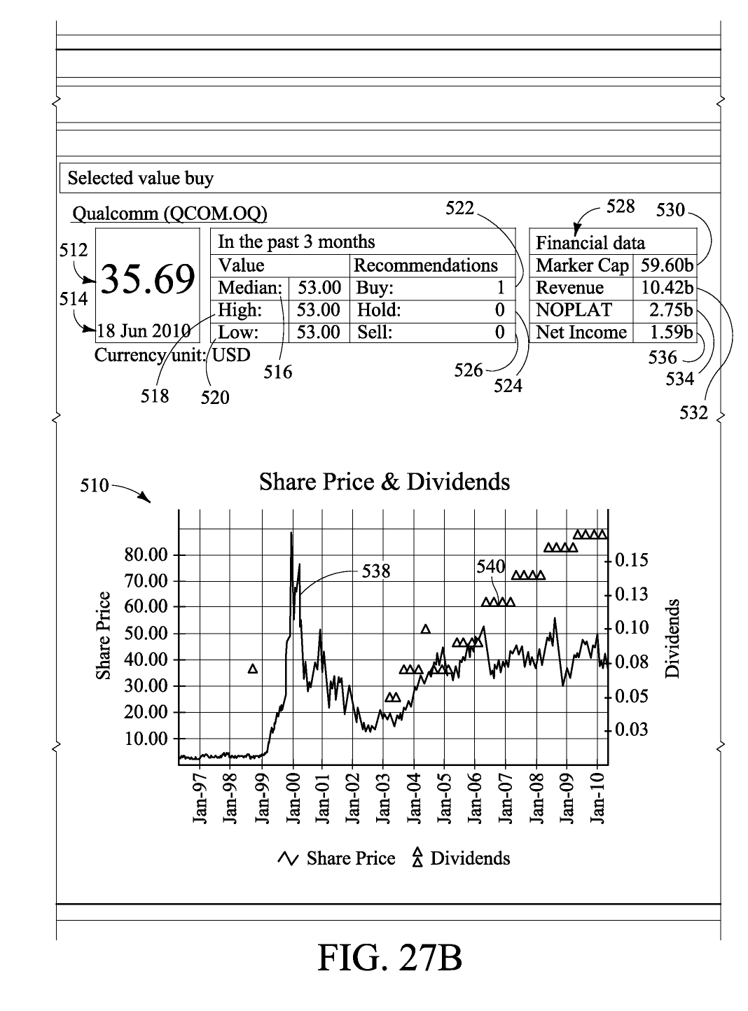

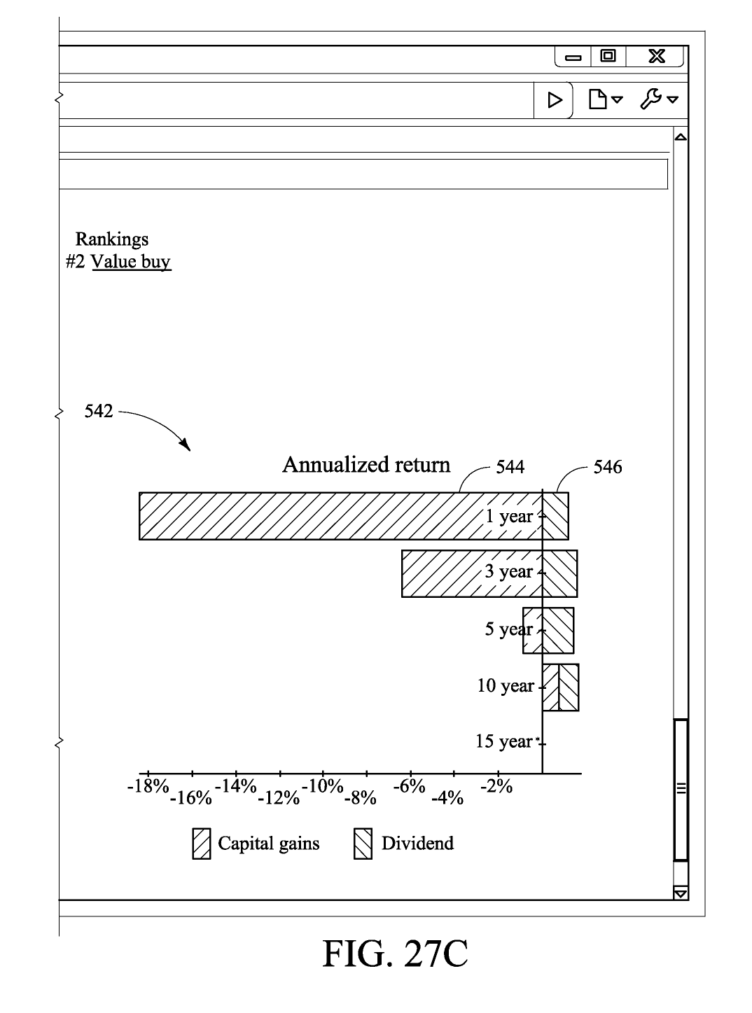

A ranking can be generated by the platform 10 or custom-made by the user as shown in Error! Reference source not found.A-C. In the embodiment shown in FIGS. 27A-C, companies can be screened based on a variety of factors such as sector 470, market capitalization 472, revenue 474, EBITDA 476, net income 478, average ROIC 480, revenue growth 482, NOPLAT growth 484, average PPE/Assets 486, and Average Debt/Assets 488. These factors are input using pull-down menus in the illustrated embodiment. Other factors and input interfaces are employed in other embodiments. In the illustrated embodiment, a search is then initiated by actuating a “Find companies” button or link 490. The results 492 are shown along with the screens used, in the illustrated embodiment, for convenience of reference to the screens 470, 472, 474, 476, 478, 480, 482, 484, 486, and 488 that were used, or shown in another screen in other embodiments. The results 492 shown in the illustrated embodiment include company names 494 and 496, last close price 498, expected price 500, and expected change 502. More or less information or other information is provided in alternative embodiments. Stock symbols can be used instead of company names, for example.

The screen shown in FIGS. 27A-C also includes, in some embodiments, for a company located in the search, such as the highest ranked company located in the search, a graph 510; a graph 542; price information 512, date 514 of the price; median, high, and low price predictions 516, 518, and 520; number of buy, hold, and sell recommendations 522, 524, and 526; and financial data 528 such as market capitalization 530, revenue 532, NOPLAT 534, and net income 536. The amount or type of information provided for a featured company varies in alternative embodiments. In the illustrated embodiment, the graph 510 for the featured company shows both share price 538 and dividends 540 on a common axis. In the illustrated embodiment, the graph 542 for the company that resulted from the search shows both capital gains 544 and dividends 546 on a common axis. More, less, or other graphs are possible.

In some embodiments, the platform 10 allows a contributor to recommend the stocks to purchase and hold and in what proportions, and update that over time.

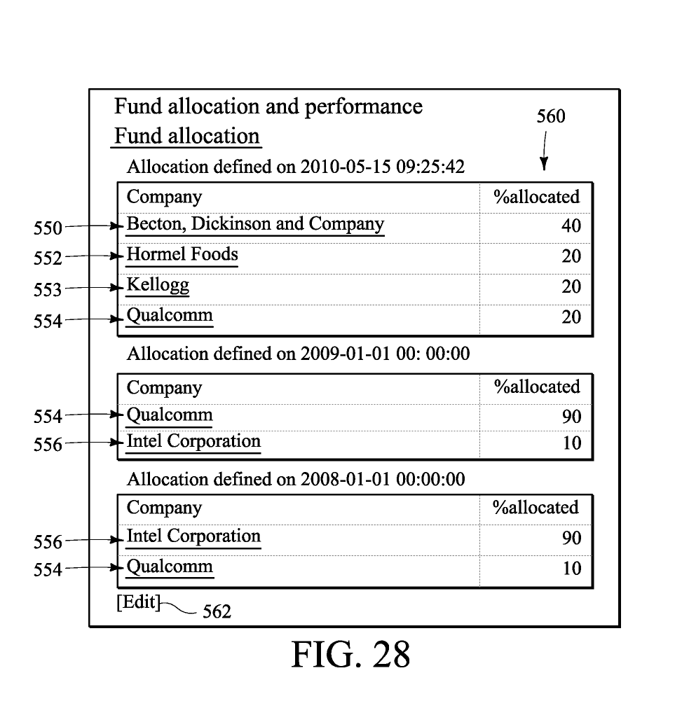

FIG. 28 illustrates that a user can define stocks 550, 552, 554, 556, and 558 in which to invest, and in what percentage 560, to define a custom fund. The user can change the makeup of the fund over time as the attractiveness to invest in a particular stock change over time. Thus, in some embodiments, a user can define a custom fund, similar to a mutual fund, by specifying stocks and proportions. In the illustrated embodiment, an Edit link or button 562 can be actuated when a user desires to edit the makeup of a fund.

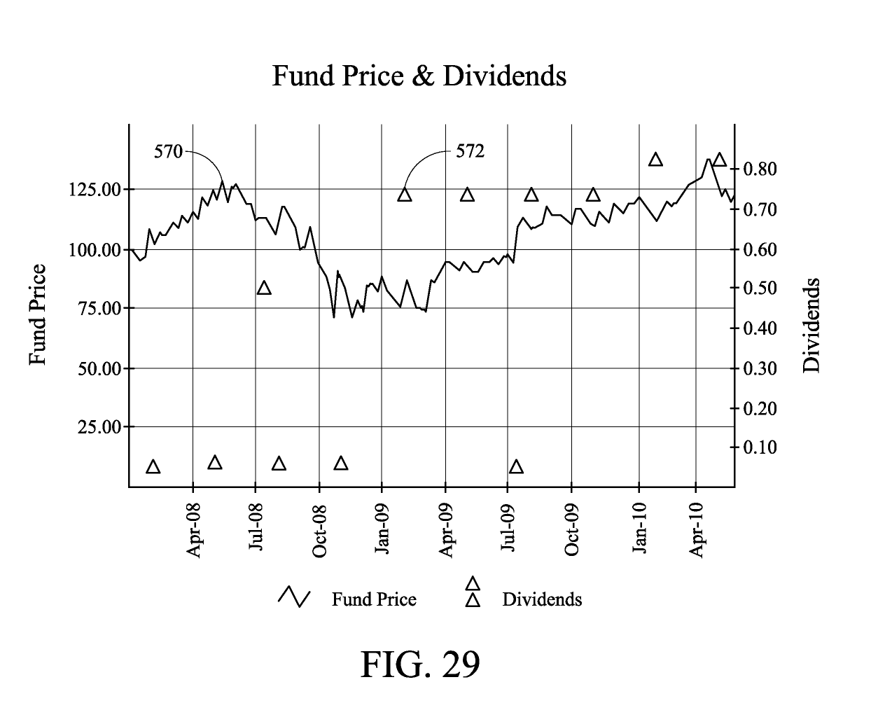

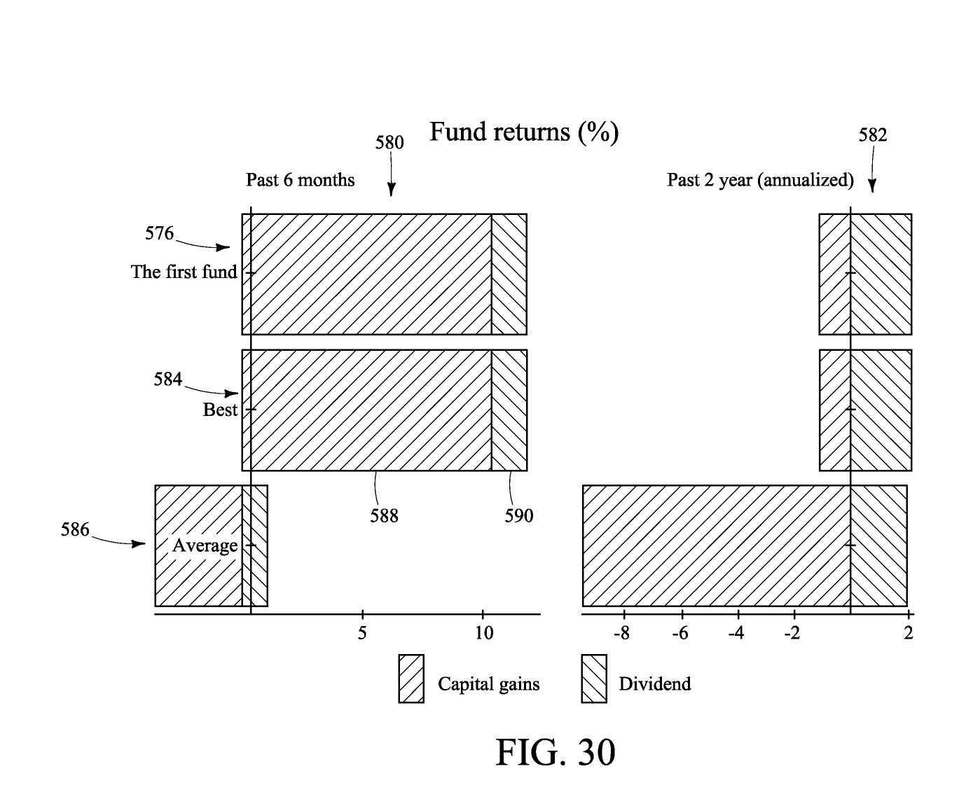

In some embodiments, the platform 10 then tracks the performance of the stocks, the value of the fund and the dividends, and total return over time of the custom funds. FIG. 29 and FIG. 30 show screen shots that are automatically drawn and updated by the platform, in various embodiments. FIG. 29 shows the value of a fund over time, assuming, for example, one hundred dollars was put in on the first day the fund was created in the proportions stipulated by the contributor, as well as the dividends that would be received. In the embodiment shown in FIG. 29, fund price 570 and dividends 572 are plotted on a common axis.

FIG. 30 show the performance of a fund 576 over different periods (e.g., the past six month 580 and the past two years 582) compared to the best fund 584 and the average fund 586 over the same periods. The latter is possible by pulling the data of the funds from the database 16. In the embodiment shown in FIG. 30, capital gains 588 and dividends 590 are plotted on a common axis.

Similar to a process described for company rankings, the platform, in various embodiments, ranks funds by at least one of: 1. historical performance of the fund; 2. percentage difference between the average expected fund price and the current fund price; 3. weighted average percentage of buys; and 4. weighted average of 1 through 3 above.

Using the database, several additional types data-mining can selectively be performed, using the system 10, to generate insights. These include, for example: 1. Most viewed company over a recent period; 2. Most searched company over a recent period; 3. Most commented company over a recent period; and 4. Company with most new entries over a recent period.

Various embodiments also provide methods to calculate and provide incentives for contributors, using incentive engine 47.

In some embodiments, users will pay a fee, such as monthly, quarterly or annual subscription fee, for use of the system 10. In some embodiments, at least some of the fees will be put in a trust fund, where dividends will be paid out annually to the contributors according to certain contributor performance metrics related to their ranking. The operating expenses of the platform is paid out of the trust fund. In some embodiments, most of the revenues from the fees, or all fees after expenses, are paid back to the contributors.

In some embodiments, users are the owners of this trust fund, and they know that they can get paid attractive dividends if they work hard and develop many good quality write-ups. This incentive scheme is made publicly known to the users and contributors. This positions the platform as a platform for the users thereby providing the motivation for contributors.

An example of a calculation for paying contributors will now be described. This is only an example and other methods are used in other embodiments.

Step 1: Input or determine the total dividend payout. This can be based, for example, on the total revenue collected that year, the financial returns of the fund and historical dividend payouts. This can also be a number that is arbitrarily specified by the operators of the system.

Step 2: Determine the composite rating for a contributor for past year

There are many ways this can be done based on the set of ratings collected and described previously. One embodiment is the following:

R*=c₁×R×w+c₂×u+c₂×s+c₃×v

Where

c1, c2 and c3 are coefficients to give different weightings, in this implementation they are 0.8, 0.1 and 0.1 respectively;

R=average rating of the contributor's new write-ups in this year;

W=number of new write-ups by contributor in this year;

u=number of distinct users that have viewed the write-ups from the contributor;

s=number of distinct users subscribing to the write-ups from the contributor; and

v=number of revisions based on the write-ups from the contributor.

Step 3: Determine what portion of the total dividend payout each contributor should get. The portion of total dividend payout would then be the ratio of a contributor's composite rating to the sum of composite ratings of all contributors:

$$P = \frac{{R}^{*}}{Σ {R}^{*}}$$

Step 4: Calculate dividend paid out to contributor by multiplying the result from Step 1 and Step 3.

While some embodiments disclosed herein are implemented in software, alternative embodiments comprise hardware, such as hardware including digital logic circuitry. Still other embodiments are implemented in a combination of software and digital logic circuitry.

Various embodiments comprise a computer-usable or computer-readable medium, such as a hard drive, solid state memory, flash drive, floppy disk, CD (read-only or rewritable), DVD (read-only or rewritable), tape, optical disk, floptical disk, RAM, ROM (or any other medium capable of storing program code) bearing computer program code which, when executed by a computer or processor, or distributed processing system, performs various of the functions described above.

Some embodiments provide a carrier wave or propagation signal, medium, or device embodying such computer program code for transfer of such code over a network or from one device to another.

In compliance with the patent statutes, the subject matter disclosed herein has been described in language more or less specific as to structural and methodical features. However, the scope of protection sought is to be limited only by the following claims, given their broadest possible interpretations. The claims are not to be limited by the specific features shown and described, as the description above only discloses example embodiments.

I/We claim:

1. A system for enabling contributors to create and share financial analysis, the system comprising:
a server configured to receive financial analysis contributions from contributors, the financial analysis contributions from respective contributors including at least a prediction of a future price for a security;
the server including a database configured to store the financial analysis contributions from contributors;
the server being configured to receive ratings of at least one of contributors and contributions; and.
the server being configured to make security price predictions based on contributions from multiple contributors, after making adjustments taking the ratings of contributors into account.

2. A system in accordance with claim 1 and wherein the server is configured to calculate amounts to compensate respective contributors based, at least in part, on the ratings.

3. A system in accordance with claim 1 and further configured to generate a graph illustrating capital gains for a security, for a period of time, and also illustrating return due to dividends for the period of time.

4. A system in accordance with claim 3 and further configured to generate a graph illustrating share price versus time and to simultaneously show dividends versus time.

5. A system in accordance with claim 1 wherein the financial analysis contributions include, for respective contributors, adjustments for perceived misstatements in a financial statement.

6. A system in accordance with claim 1 and configured to make a consensus calculation, using adjustments from multiple contributors, for a number in a financial statement.

7. A system in accordance with claim 1 and further configured to generate a graph of enterprise value decomposition.

8. A system in accordance with claim 1 and configured to input weighted average cost of capital, return on invested capital, invested capital, and invested capital growth, and computes enterprise value.

9. A system in accordance with claim 8 and further configured to compute share value based, in part, on the computed enterprise value.

10. A system in accordance with claim 1 and configured to input screening criteria and to output rankings of securities based on at least the screening criteria and security price predictions.

11. A system in accordance with claim 1 and configured to present a model template to a contributor, the template having weighted average cost of capital, return on invested capital, invested capital, and invested capital growth as inputs, and the system being configured to compute enterprise value using the template inputs.

12. A system in accordance with claim 1 wherein the financial analysis contributions further include write-ups including commentary about the security, and wherein the system is configured to aggregate financial analysis contributions from different contributors.

13. A method for enabling contributors to create and share financial analysis, the method comprising:
presenting financial statement numbers reported by a company;
receiving financial analysis contributions from contributors, the financial analysis contributions from respective contributors including accounting adjustments representing suggested modifications to the accounting numbers, and the financial analysis contributions including commentary on the company by the contributors;
storing accounting adjustments from respective contributors; and
calculating, using a processor, financial data, using accounting adjustments from multiple of the contributors.

14. A method in accordance with claim 13 wherein the financial data calculated using accounting adjustments comprises net operating profit after taxes, invested capital, total debt and debt equivalents, and total equity and equity equivalents for the company.

15. A method in accordance with claim 13 and further comprising receiving ratings of contributors or contributions and using the ratings in the calculation of the financial data.

16. A method in accordance with claim 13 and further comprising outputting a screen including commentary by a contributor as well as a graph selected from the group consisting of: a sales and profit graph; an ROIC decomposition graph; a NOPLAT analysis graph; an invested capital analysis graph; and an asset analysis graph.

17. A method in accordance with claim 13 and further comprising outputting a screen including commentary by a contributor as well as a graph comparing the company to another company.

18. A method in accordance with claim 13 and further comprising storing, in a memory, a revision history including data indicating who made contributions and when.

19. A memory bearing computer program code which, when executed in a computer, causes the computer to perform the method of claim 13.

20. A method for enabling contributors to create and share financial analysis, the method comprising:
receiving financial analysis contributions from contributors, the financial analysis contributions from contributors including at least commentary for a security;
storing the financial analysis contributions from contributors;
receiving a definition of a custom fund from a contributor, the custom fund definition including specification of multiple companies and how much of each company to include;
tracking performance of respective funds;
generating a graph of fund performance relative to time; and
receiving revisions of definitions of funds.

21. A method in accordance with claim 20 wherein the custom fund definition comprises specification of securities and percentage allocation of the securities in the custom fund.

22. A method in accordance with claim 20 wherein generating a graph comprises generating a graph showing both fund price and dividends versus time.

23. A method in accordance with claim 20 wherein generating a graph comprises generating a graph comparing returns of the custom fund to returns of other funds.

24. A method in accordance with claim 20 wherein generating a graph comprises generating a graph showing both capital gains and dividends of the custom fund and of other funds versus time.
